(19) United States
(12) Patent Application Publication
(10) Pub. No.: US 2026/0286817 A1
(43) Pub. Date: Sep. 24, 2026

(54) CONVENTIONAL CHEMICAL EOR APPLICATION WITHOUT SALINITY GRADIENT

(71) Applicant: CHEVRON U.S.A. INC., San Ramon, CA (US)

(72) Inventors: Gayani W. PINNAWALA, Katy, TX (US); David Enrique TORRES LOPEZ, Houston, TX (US); Christopher Adam GRIFFITH, Houston, TX (US); Mohsen Siyed TAGAVIFAR, Houston, TX (US); Varadarajan DWARAKANATH, Houston, TX (US); Kahnery Lee MAI, Fulshear, TX (US)

(21) Appl. No.: 19/571,059

(22) Filed: Mar. 18, 2026

Related U.S. Application Data
(60) Provisional application No. 63/774,013, filed on Mar. 18, 2025.

(51) Int. Cl. E21B 43/16; C09K 8/584

(52) U.S. Cl. CPC E21B 43/16; C09K 8/584

(57) ABSTRACT

Described herein are methods for hydrocarbon recovery from a subterranean formation.

### CROSS-REFERENCE TO RELATED APPLICATION

This application claims priority to, and the benefit of U.S. Provisional Application 63/774,013, filed on Mar. 18, 2025, the contents of which is hereby incorporated by reference in its entirety.

### BACKGROUND

Enhanced oil recovery (EOR) is an increasingly important supplemental technique for recovering oil from a reservoir after primary and secondary recovery. Many hydrocarbon reservoirs trap a significant amount of oil that is bound tightly and difficult to remove by traditional water flooding methods. There is an ongoing need to develop cost-effective and improved methods for oil recovery from hydrocarbon reservoirs.

The compositions and methods disclosed herein address these and other needs.

### SUMMARY

Described herein are methods for hydrocarbon recovery from a subterranean formation, the method including: injecting a first aqueous formulation comprising a surfactant package, and a miscible solvent at a constant salinity into the subterranean formation via a wellbore in fluid communication with the subterranean formation; and producing fluids from the subterranean formation through the wellbore, a production wellbore spaced apart from the wellbore a predetermined distance and in fluid communication with the subterranean formation, or any combination thereof.

Described herein are methods for hydrocarbon recovery from a subterranean formation, the method including: injecting a first aqueous formulation comprising a surfactant package, and a miscible solvent at a constant salinity into the subterranean formation via an injection wellbore in fluid communication with the subterranean formation; and producing fluids from the subterranean formation through production wellbore spaced apart from the injection wellbore a predetermined distance and in fluid communication with the subterranean formation.

Described herein are methods for hydrocarbon recovery from a subterranean formation, the method including: injecting a first aqueous formulation including a surfactant package, and a miscible solvent at a constant salinity into the subterranean formation via a wellbore in fluid communication with the subterranean formation; allowing the first aqueous formulation to contact a rock matrix of the subterranean formation for a period of time; and producing fluids from the subterranean formation through the wellbore.

Also, described herein are methods for hydrocarbon recovery from a subterranean formation, the method including: injecting a first aqueous formulation including surfactant package and a miscible solvent at a constant salinity into the subterranean formation via a wellbore in fluid communication with the subterranean formation, wherein the miscible solvent can be present in the first aqueous formulation in an effective amount such that, in the presence of formation fluids, the first aqueous formulation and the formation fluids passes through a Winsor type III phase, thereby providing ultra-low interfacial tension between oil and aqueous phases; and producing fluids from the subterranean formation through the wellbore, a production wellbore spaced apart from the wellbore a predetermined distance and in fluid communication with the subterranean formation, or any combination thereof.

Also, described herein are methods for hydrocarbon recovery from a subterranean formation, the method including: injecting a first aqueous formulation including surfactant package and a miscible solvent at a constant salinity into the subterranean formation via an injection wellbore in fluid communication with the subterranean formation, wherein the miscible solvent can be present in the first aqueous formulation in an effective amount wherein the miscible solvent is present in the first aqueous formulation in an amount effective such that, in the presence of formation fluids, the first aqueous formulation and the formation fluids passes through a Winsor type III phase, thereby providing ultra-low interfacial tension between oil and aqueous phases; and producing fluids from the subterranean formation through a production wellbore spaced apart from the injection wellbore a predetermined distance and in fluid communication with the subterranean formation.

Also, described herein are methods for hydrocarbon recovery from a subterranean formation, the method including: injecting a first aqueous formulation including surfactant package and a miscible solvent at a constant salinity into the subterranean formation via a wellbore in fluid communication with the subterranean formation, wherein the miscible solvent can be present in the first aqueous formulation in an effective amount such that, in the presence of formation fluids, the first aqueous formulation and the formation fluids passes through a Winsor type III phase, thereby providing ultra-low interfacial tension between oil and aqueous phases; allowing the first aqueous formulation to contact a rock matrix of the subterranean formation for a period of time; and producing fluids from the subterranean formation through the wellbore.

In some embodiments, the miscible solvent can be present in the first aqueous formulation in a concentration of from 0.1% by weight to 20% by weight.

In some embodiments, the miscible solvent and the surfactant package can be present in the first aqueous formulation in a ratio of from 1:0.0005 to 1:200 (e.g., 1:10 or 1:1).

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 is a graph of phase behavior without DME (Salinity scan) at 44° C.

FIG. 2 is a graph showing viscosity measurements for the oil with different two solvent (DME and 4M2P). Oil with API gravity of 18-20.

FIG. 3 are images showing phase behavior for light oil based on the effect of different concentrations of DME at 37,000 ppm TDS, 44° C. (111° F.), and 150 psia and with formulation 1 (0.3% disulfonate, 0.5% alkyl alkoxy sulfate, 0.65% IOS, 2% TEGBE).

FIG. 4 is an image showing solubilization ratio versus salinity based on β parameter for miscible solvent solubility in oil or water.

FIG. 5 is a graph showing how different miscible solvents shift phase behavior for a formulations including 1.4% surfactant, 0.83% EGBE, 2.17% miscible solvent (e.g., 4M2P, EGBE, DEGBE, and TEGBE) in crude oil.

FIG. 6 is a graph showing the effect of miscible solvent concentration on salinity for a formulation including 1.4% surfactant, 0.83% EGBE, and different concentration of different miscible solvent (e.g., TEGBE, IBA-1PO-2EO, DEGBE, sec-butanol, EGBE, and 4M2P).

FIG. 7 is a graph showing the effect of miscible solvent concentration on optimum salinity for a formulation including 1.4% surfactant with different concentrations of DEGBE (1.5% and 2.2%), different concentrations of 4M2P (1% and 2.2%), and mixture of DEGBE and 4M2P (0.7%+1.4%) in crude oil.

FIG. 8 is an image showing phase behavior when decreasing miscible solvent concentration, at constant salinity with a formulation including 1.4% surfactant, 0.7% DEGBE, and initial concentration of 1.4% 4M2P in crude oil (dilution scan between surfactant slug and injection brine at constant salinity).

FIG. 9 is a graph showing the effective salinity versus pore volumes injected for formulation including 1.4% surfactant, 0.83% EGBE, 0.7% DEGBE, and 1.4% 4M2P in crude oil.

FIG. 10 is a graph showing the microemulsion viscosity with a formulation including 1.4% surfactant, different concentration of EGBE, and different concentrations of different miscible solvent in crude oil with a shear rate of 10 s⁻¹.

FIG. 11 is a graph showing the results of core flood studies using DME, surfactants, and polymer.

FIG. 12 are images showing the progression of effluent emulsion during oil production.

FIG. 13 is an image showing phase behavior for light oil based on the effect of different concentrations of TEGBE at 37,000 ppm TDS, 44° C. (111° F.), with formulation 1 (0.3% disulfonate, 0.5% alkyl alkoxy sulfate, 0.65% IOS, 2% TEGBE).

FIG. 14 is a graph showing tracer response for three core conditions (virgin core, sorw, and sorc. The virgin core represents the core before oil saturation and reflects the total accessible pore volume at 100% brine saturation. Sorw corresponds to the residual oil saturation after waterflooding and shows a reduction in accessible volume due to the presence of oil. Sorc represents the residual oil saturation after chemical treatment.

Like reference symbols in the various drawings indicate like elements.

### DETAILED DESCRIPTION

A number of embodiments of the disclosure have been described. Nevertheless, it will be understood that various modifications may be made without departing from the spirit and scope of the invention. Accordingly, other embodiments are within the scope of the following claims.

### Definitions

To facilitate understanding of the disclosure set forth herein, a number of terms are defined below. Unless defined otherwise, all technical and scientific terms used herein generally have the same meaning as commonly understood by one of ordinary skill in the art to which this disclosure belongs. Unless otherwise specified, all percentages are in weight percent and the pressure is in atmospheres. All citations referred to herein are expressly incorporated by reference.

### General Definitions

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Other than where noted, all numbers expressing quantities of ingredients, reaction conditions, geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Accordingly, these terms are intended to not only cover the recited element(s) or step(s), but may also include other elements or steps not expressly recited. Furthermore, as used herein, the use of the terms “a”, “an”, and “the” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

Ranges can be expressed herein as from “about” one particular value, and/or to “about” another particular value. By “about” is meant within 10% of the value, e.g., within 9, 8, 7, 6, 5, 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. A range may be construed to include the start and the end of the range. For example, a range of 10% to 20% (i.e., range of 10%-20%) can includes 10% and also includes 20%, and includes percentages in between 10% and 20%, unless explicitly stated otherwise herein.

As used herein, the terms “may,” “optionally,” and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if a composition is described herein as including a component of type A, a component of type B, a component of type C, or any combination thereof, it is understood that this phrase describes all of the various individual and collective combinations and permutations of these components. For example, in some embodiments, the composition described by this phrase could include only a component of type A. In some embodiments, the composition described by this phrase could include only a component of type B. In some embodiments, the composition described by this phrase could include only a component of type C. In some embodiments, the composition described by this phrase could include a component of type A and a component of type B. In some embodiments, the composition described by this phrase could include a component of type A and a component of type C. In some embodiments, the composition described by this phrase could include a component of type B and a component of type C. In some embodiments, the composition described by this phrase could include a component of type A, a component of type B, and a component of type C. In some embodiments, the composition described by this phrase could include two or more components of type A (e.g., A1 and A2). In some embodiments, the composition described by this phrase could include two or more components of type B (e.g., B1 and B2). In some embodiments, the composition described by this phrase could include two or more components of type C (e.g., C1 and C2). In some embodiments, the composition described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the composition described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the composition described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

The term “hydrocarbon” refers to a compound containing only carbon and hydrogen atoms.

“Hydrocarbon-bearing formation” or simply “formation” refers to the rock matrix in which a wellbore may be drilled. For example, a formation refers to a body of rock that is sufficiently distinctive and continuous such that it can be mapped. It should be appreciated that while the term “formation” generally refers to geologic formations of interest, that the term “formation,” as used herein, may, in some instances, include any geologic points or volumes of interest (such as a survey area).

“Unconventional formation” is a subterranean hydrocarbon-bearing formation that generally requires intervention in order to recover hydrocarbons from the reservoir at economic flow rates or volumes. For example, an unconventional formation includes reservoirs having an unconventional microstructure in which fractures are used to recover hydrocarbons from the reservoir at sufficient flow rates or volumes (e.g., an unconventional reservoir generally needs to be fractured under pressure or have naturally occurring fractures in order to recover hydrocarbons from the reservoir at sufficient flow rates or volumes).

In some embodiments, the unconventional formation can include a reservoir having a permeability of less than 25 millidarcy (mD) (e.g., 20 mD or less, 15 mD or less, 10 mD or less, 5 mD or less, 1 mD or less, 0.5 mD or less, 0.1 mD or less, 0.05 mD or less, 0.01 mD or less, 0.005 mD or less, 0.001 mD or less, 0.0005 mD or less, 0.0001 mD or less, 0.00005 mD or less, 0.00001 mD or less, 0.000005 mD or less, or 0.000001 mD or less). In some embodiments, the unconventional formation can include a reservoir having a permeability of at least 0.000001 mD (e.g., at least 0.000005 mD, at least 0.00001 mD, 0.00005 mD, at least 0.0001 mD, 0.0005 mD, 0.001 mD, at least 0.005 mD, at least 0.01 mD, at least 0.05 mD, at least 0.1 mD, at least 0.5 mD, at least 1 mD, at least 5 mD, at least 10 mD, at least 15 mD, or at least 20 mD).

The unconventional formation can include a reservoir having a permeability ranging from any of the minimum values described above to any of the maximum values described above. For example, in some embodiments, the unconventional formation can include a reservoir having a permeability of from 0.000001 mD to 25 mD (e.g., from 0.001 mD to 25 mD, from 0.001 mD to 10 mD, from 0.01 mD to 10 mD, from 0.1 mD to 10 mD, from 0.001 mD to 5 mD, from 0.01 mD to 5 mD, or from 0.1 mD to 5 mD). The permeability of a particular formation can be determined by averaging measured permeability values from a series of representative core samples obtained from the formation.

“Conventional formation” refers to a subterranean hydrocarbon-bearing formation that can include a permeability greater than 25 mD (e.g., from 25 mD to 5 D, from 25 mD to 10 D, from 25 mD to 15 D, from 25 mD to 20 D, from 25 mD to 25 D, from 25 mD to 50 D, from 25 mD to 75 D, from 25 mD to 100 D, from 250 mD to 5 D, from 250 mD to 10 D, from 250 mD to 15 D, from 250 mD to 20 D, from 250 mD to 25 D, from 250 mD to 50 D, from 250 mD to 75 D, from 250 mD to 100 D, from 500 mD to 5 D, from 500 mD to 10 D, from 500 mD to 15 D, from 500 mD to 20 D, from 500 mD to 25 D, from 500 mD to 50 D, from 500 mD to 75 D, from 500 mD to 100 D, from 1 D to 5 D, from 1 D to 10 D, from 1 D to 15 D, from 1 D to 20 D, from 1 D to 25 D, from D to 50 D, from 1 D to 75 D, from 1 D to 100 D, from 5 D to 10 D, from 5 D to 15 D, from 5 D to 20 D, from 5 D to 25 D, from 5 D to 50 D, from 5 D to 75 D, from 5 D to 100 D, from 10 D to 15 D, from 10 D to 20 D, from 10 D to 25 D, from 10 D to 50 D, from 10 D to 75 D, from 10 D to 100 D, from 25 D to 50 D, from 25 D to 75 D, from 25 D to 100 D, from 50 D to 75 D, or from 50 D to 100 D).

The formation may include faults, fractures (e.g., naturally occurring fractures, fractures created through hydraulic fracturing, etc.), geobodies, overburdens, underburdens, horizons, salts, salt welds, etc. The formation may be onshore, offshore (e.g., shallow water, deep water, etc.), etc. Furthermore, the formation may include hydrocarbons, such as liquid hydrocarbons (also known as oil or petroleum), gas hydrocarbons, a combination of liquid hydrocarbons and gas hydrocarbons (e.g., including gas condensate), etc.

The formation, the hydrocarbons, or both may also include non-hydrocarbon items, such as pore space, connate water, brine, fluids from enhanced oil recovery, etc. The formation may also be divided up into one or more hydrocarbon zones, and hydrocarbons can be produced from each desired hydrocarbon zone.

The term formation may be used synonymously with the term “reservoir” or “subsurface reservoir” or “subsurface region of interest” or “subsurface formation” or “subsurface volume of interest” or “subterranean formation”. For example, in some embodiments, the reservoir may be, but is not limited to, a shale reservoir, a carbonate reservoir, a tight sandstone reservoir, a tight siltstone reservoir, etc. Indeed, the terms “formation,” “hydrocarbon,” and the like are not limited to any description or configuration described herein.

A “wellbore” refers to a single hole, usually cylindrical, that is drilled into a subsurface volume of interest. A wellbore may be drilled in one or more directions. For example, a wellbore may include a vertical wellbore, a horizontal wellbore, a deviated wellbore, and/or other type of wellbore. A wellbore may be drilled in the formation for exploration and/or recovery of resources. For example, a wellbore may be drilled in the formation to aid in extraction and/or production of resources such as hydrocarbons. As another example, a wellbore may be drilled in the formation for fluid injection. A plurality of wellbores (e.g., tens to hundreds of wellbores) are often used in a field depending on the desired outcome.

A wellbore may be drilled into a formation using practically any drilling technique and equipment known in the art, such as geosteering, directional drilling, etc. Drilling the wellbore may include using a tool, such as a drilling tool that includes a drill bit and a drill string. Drilling fluid, such as drilling mud, may be used while drilling in order to cool the drill tool and remove cuttings. Other tools may also be used while drilling or after drilling, such as measurement-while-drilling (MWD) tools, seismic-while-drilling (SWD) tools, wireline tools, logging-while-drilling (LWD) tools, or other downhole tools. After drilling to a predetermined depth, the drill string and the drill bit may be removed, and then the casing, the tubing, and/or other equipment may be installed according to the design of the wellbore may be installed according to the design of the wellbore. The equipment to be used in drilling the wellbore may be dependent on the design of the wellbore, the formation, the hydrocarbons, and/or other factors.

A wellbore may include a plurality of components, such as, but not limited to, a casing, a liner, a tubing string, a sensor, a packer, a screen, a gravel pack, artificial lift equipment (e.g., an electric submersible pump (ESP)), and/or other components. If a wellbore is drilled offshore, the wellbore may include one or more of the previous components plus other offshore components, such as a riser. A wellbore may also include equipment to control fluid flow into the wellbore, control fluid flow out of the wellbore, or any combination thereof. For example, a wellbore may include a wellhead, a choke, a valve, and/or other control devices. These control devices may be located on the surface, in the subsurface (e.g., downhole in the wellbore), or any combination thereof. In some embodiments, the same control devices may be used to control fluid flow into and out of the wellbore. In some embodiments, different control devices may be used to control fluid flow into and out of a wellbore. In some embodiments, the rate of flow of fluids through the wellbore may depend on the fluid handling capacities of the surface facility that is in fluidic communication with the wellbore. The equipment to be used in controlling fluid flow into and out of a wellbore may be dependent on the wellbore, the formation, the surface facility, and/or other factors. Moreover, sand control equipment and/or sand monitoring equipment may also be installed (e.g., downhole and/or on the surface). A wellbore may also include any completion hardware that is not discussed separately. The term “wellbore” may be used synonymously with the terms “borehole,” “well,” or “well bore.” The term “wellbore” is not limited to any description or configuration described herein.

The term “interfacial tension” or “IFT” as used herein refers to the surface tension between test oil and water of different salinities containing a surfactant formulation at different concentrations. Typically, interfacial tensions are measured using a spinning drop tensiometer or calculated from phase behavior experiments.

The term “proximate” is defined as “near”. If item A is proximate to item B, then item A is near item B. For example, in some embodiments, item A may be in contact with item B. For example, in some embodiments, there may be at least one barrier between item A and item B such that item A and item B are near each other, but not in contact with each other. The barrier may be a fluid barrier, a non-fluid barrier (e.g., a structural barrier), or any combination thereof. Both scenarios are contemplated within the meaning of the term “proximate.”

The terms “unrefined petroleum” and “crude oil” are used interchangeably and in keeping with the plain ordinary usage of those terms. “Unrefined petroleum” and “crude oil” may be found in a variety of petroleum reservoirs (also referred to herein as a “reservoir,” “oil field deposit” “deposit” and the like) and in a variety of forms including oleaginous materials, oil shales (i.e., organic-rich fine-grained sedimentary rock), tar sands, light oil deposits, heavy oil deposits, and the like. “Crude oils” or “unrefined petroleums” generally refer to a mixture of naturally occurring hydrocarbons that may be refined into diesel, gasoline, heating oil, jet fuel, kerosene, and other products called fuels or petrochemicals. Crude oils or unrefined petroleums are named according to their contents and origins, and are classified according to their per unit weight (specific gravity). Heavier crudes generally yield more heat upon burning, but have lower gravity as defined by the American Petroleum Institute (API) (i.e., API gravity) and market price in comparison to light (or sweet) crude oils. Crude oil may also be characterized by its Equivalent Alkane Carbon Number (EACN). The term “API gravity” refers to the measure of how heavy or light a petroleum liquid is compared to water. If an oil's API gravity is greater than 10, it is lighter and floats on water, whereas if it is less than 10, it is heavier and sinks. API gravity is thus an inverse measure of the relative density of a petroleum liquid and the density of water. API gravity may also be used to compare the relative densities of petroleum liquids. For example, if one petroleum liquid floats on another and is therefore less dense, it has a greater API gravity.

Crude oils vary widely in appearance and viscosity from field to field. They range in color, odor, and in the properties they contain. While all crude oils are mostly hydrocarbons, the differences in properties, especially the variation in molecular structure, determine whether a crude oil is more or less easy to produce, pipeline, and refine. The variations may even influence its suitability for certain products and the quality of those products. Crude oils are roughly classified into three groups, according to the nature of the hydrocarbons they contain. (i) Paraffin-based crude oils contain higher molecular weight paraffins, which are solid at room temperature, but little or no asphaltic (bituminous) matter. They can produce high-grade lubricating oils. (ii) Asphaltene based crude oils contain large proportions of asphaltic matter, and little or no paraffin. Some are predominantly naphthenes and so yield lubricating oils that are sensitive to temperature changes than the paraffin-based crudes. (iii) Mixed based crude oils contain both paraffin and naphthenes, as well as aromatic hydrocarbons. Most crude oils fit this latter category.

“Reactive” crude oil, as referred to herein, is crude oil containing natural organic acidic components (also referred to herein as unrefined petroleum acid) or their precursors such as esters or lactones. These reactive crude oils can generate soaps (carboxylates) when reacted with alkali. More terms used interchangeably for crude oil throughout this disclosure are hydrocarbons, hydrocarbon material, or active petroleum material. An “oil bank” or “oil cut” as referred to herein, is the crude oil that does not contain the injected chemicals and is pushed by the injected fluid during an enhanced oil recovery process. A “nonactive oil,” as used herein, refers to an oil that is not substantially reactive or crude oil not containing significant amounts of natural organic acidic components or their precursors such as esters or lactones such that significant amounts of soaps are generated when reacted with alkali. A nonactive oil as referred to herein includes oils having an acid number of less than 0.5 mg KOH/g of oil.

“Unrefined petroleum acids” as referred to herein are carboxylic acids contained in active petroleum material (reactive crude oil). The unrefined petroleum acids contain C₁₁-C₂₀ alkyl chains, including napthenic acid mixtures. The recovery of such “reactive” oils may be performed using alkali (e.g., NaOH, NaHCO₃, or Na₂CO₃) in a surfactant composition. The alkali reacts with the acid in the reactive oil to form soap in situ. These in situ generated soaps serve as a source of surfactants minimizing the levels of added surfactants, thus enabling efficient oil recovery from the reservoir.

The term “polymer” refers to a molecule having a structure that essentially includes the multiple repetitions of units derived, actually or conceptually, from molecules of low relative molecular mass. In some embodiments, the polymer is an oligomer.

The term “productivity” as applied to a petroleum or oil well refers to the capacity of a well to produce hydrocarbons (e.g., unrefined petroleum); that is, the ratio of the hydrocarbon flow rate to the pressure drop, where the pressure drop is the difference between the average reservoir pressure and the flowing bottom hole well pressure (i.e., flow per unit of driving force).

“Viscosity” refers to a fluid's internal resistance to flow or being deformed by shear or tensile stress. In other words, viscosity may be defined as thickness or internal friction of a liquid. Thus, water is “thin”, having a lower viscosity, while oil is “thick”, having a higher viscosity. More generally, the less viscous a fluid is, the greater its ease of fluidity.

The term “salinity” as used herein, refers to concentration of salt dissolved in an aqueous phase. Examples for such salts are without limitation, sodium chloride, magnesium and calcium sulfates, and bicarbonates. In particular, the term salinity as it pertains to the present invention refers to the concentration of salts in brine and surfactant solutions.

Unless defined otherwise, all technical and scientific terms used herein have the same meanings as commonly understood by one of skill in the art to which the disclosed invention belongs. Unless otherwise specified, all percentages are in weight percent and the pressure is in atmospheres.

“Friction reducer,” as used herein, refers to a chemical additive that alters fluid rheological properties to reduce friction created within the fluid as it flows through small-diameter tubulars or similar restrictions (e.g., valves, pumps). Generally polymers, or similar friction reducing agents, add viscosity to the fluid, which reduces the turbulence induced as the fluid flows. Reductions in fluid friction of greater than 50% are possible depending on the friction reducer utilized, which allows the injection fluid to be injected into a wellbore at a much higher injection rate (e.g., between 60 to 100 barrels per minute) and also lower pumping pressure during proppant injection.

“Injection fluid,” as used herein, refers to any fluid which is injected into a reservoir via a well. “Fracturing fluid,” as used herein, refers to an injection fluid that is injected into the well under pressure in order to cause fracturing within a portion of the reservoir.

Unless defined otherwise, all technical and scientific terms used herein have the same meanings as commonly understood by one of skill in the art to which the disclosed invention belongs. Unless otherwise specified, all percentages are in weight percent and the pressure is in atmospheres Reference will now be made in detail to specific aspects of the disclosed materials, compounds, compositions, articles, and methods, examples of which are illustrated in the accompanying Examples and Figures.

### Methods

Described herein are methods for hydrocarbon recovery from a subterranean formation, the method including: injecting a first aqueous formulation comprising a surfactant package, and a miscible solvent at a constant salinity into the subterranean formation via a wellbore in fluid communication with the subterranean formation; and producing fluids from the subterranean formation through the wellbore, production wellbore spaced apart from the wellbore a predetermined distance and in fluid communication with the subterranean formation, or any combination thereof.

Described herein are methods for hydrocarbon recovery from a subterranean formation, the method including: injecting a first aqueous formulation including a surfactant package, and a miscible solvent at a constant salinity into the subterranean formation via a wellbore in fluid communication with the subterranean formation; allowing the first aqueous formulation to contact a rock matrix of the subterranean formation for a period of time; and producing fluids from the subterranean formation through the wellbore. In some embodiments, the miscible solvent can be present in the first aqueous formulation in an effective amount such that, in the presence of formation fluids, the first aqueous formulation and the formation fluids passes through a Winsor type III phase, thereby providing ultra-low interfacial tension between oil and aqueous phases.

Also, described herein are methods for improving hydrocarbon production from subterranean formation that include injecting a first aqueous formulation including a surfactant package, and a miscible solvent at a constant salinity into the subterranean formation via a wellbore in fluid communication with the subterranean formation. In some embodiment, the method can further include allowing the first aqueous formulation to contact a rock matrix of the subterranean formation for a period of time. In some embodiment, the method can further include producing fluids from the subterranean formation through the wellbore, production wellbore spaced apart from the wellbore a predetermined distance and in fluid communication with the subterranean formation, or any combination thereof.

For example, described herein are methods for improving hydrocarbon production from subterranean formation that include injecting a first aqueous formulation including a surfactant package, and a miscible solvent at a constant salinity into the subterranean formation via a wellbore in fluid communication with the subterranean formation; and allowing the first aqueous formulation to contact a rock matrix of the subterranean formation for a period of time.

In some embodiments, the methods can further include producing fluids including the hydrocarbons from the subterranean formation.

For example, described herein are methods for improving hydrocarbon production from subterranean formation that include injecting a first aqueous formulation including a surfactant package, and a miscible solvent at a constant salinity into the subterranean formation via an injection wellbore in fluid communication with the subterranean formation; and producing fluids from the subterranean formation through production wellbore spaced apart from the wellbore a predetermined distance and in fluid communication with the subterranean formation, or any combination thereof.

In some embodiments, the methods can further include injecting a second aqueous formulation including a surfactant package, and a miscible solvent at a constant salinity into the subterranean formation via a wellbore in fluid communication with the subterranean formation. In some embodiments, the miscible solvent can be present in the second aqueous formulation in an effective amount to produce a type I microemulsions. In some embodiments, the miscible solvent can be present in the second aqueous formulation in a concentration lower than a concentration of a same miscible solvent in the first aqueous formulation. In some embodiments, injecting the second aqueous formulation can take place after the injection of the first aqueous formulation.

Described herein are methods for hydrocarbon recovery from a subterranean formation, the method including: injecting a first aqueous formulation including surfactant package and a miscible solvent at a constant salinity into the subterranean formation via a wellbore in fluid communication with the subterranean formation, wherein the miscible solvent can be present in the first aqueous formulation in an effective amount such that, in the presence of formation fluids, the first aqueous formulation and the formation fluids passes through a Winsor type III phase, thereby providing ultra-low interfacial tension between oil and aqueous phases; and producing fluids from the subterranean formation through the wellbore, a production wellbore spaced apart from the wellbore a predetermined distance and in fluid communication with the subterranean formation, or any combination thereof.

Described herein are also method for hydrocarbon recovery from a subterranean formation, the method including: injecting a first aqueous formulation including surfactant package and a miscible solvent at a constant salinity into the subterranean formation via a wellbore in fluid communication with the subterranean formation, wherein the miscible solvent is present in the first aqueous formulation in an effective amount such that, in the presence of formation fluids, the first aqueous formulation and the formation fluids passes through a Winsor type III phase, thereby providing ultra-low interfacial tension between oil and aqueous phases; allowing the first aqueous formulation to contact a rock matrix of the subterranean formation for a period of time; and producing fluids from the subterranean formation through the wellbore.

In some embodiments, the method can further include injecting a second aqueous formulation including surfactant package and a miscible solvent at a constant salinity into the subterranean formation via a wellbore in fluid communication with the subterranean formation.

The term “constant salinity” as used herein refers to formulations described herein that maintain an approximately constant salinity (TDS) over time (e.g., ±10%, ±5%, ±1%, ±0.5%, or 0.1%).

In some embodiments, the miscible solvent can be present in the second aqueous formulation in an effective amount to produce a type I microemulsions. In some embodiments, the miscible solvent can be present in the second aqueous formulation in a concentration lower than a concentration of a same miscible solvent in the first aqueous formulation.

In some embodiments, the subterranean formations can be an unconventional subterranean formation. In some embodiments, the subterranean formations can be a conventional subterranean formation.

In some embodiments, the methods can further include producing fluids including the hydrocarbons from the subterranean formation.

In some embodiments, the first aqueous formulation can be allowed to contact the rock matrix of the subterranean formation for varying periods of time. In some examples, the first aqueous formulation can be allowed to contact the rock matrix of the subterranean formation for at least one day (e.g., at least two days, at least three days, at least four days, at least five days, at least six days, at least one week, at least two weeks, at least three weeks, at least one month, at least two months, at least three months, at least four months, or at least five months). In some examples, the first aqueous formulation can be allowed to contact the rock matrix of the subterranean formation for six months or less (e.g., five months or less, four months or less, three months or less, two months or less, one month or less, three weeks or less, two weeks or less, one week or less, six days or less, five days or less, four days or less, three days or less, or two days or less).

The first aqueous formulation can be allowed to contact the rock matrix of the subterranean formation for a period of time ranging from any of the minimum values described above to any of the maximum values described above. For example, the first aqueous formulation can be allowed to contact the rock matrix the subterranean formation for from one day to six months (e.g., from one day to three months, from one day to one month, or from one day to two weeks).

In one example, the wellbore can be a new wellbore, and the first aqueous formulation can be allowed to contact the rock matrix of the subterranean formation for from two weeks to one month. In another example, the wellbore can be a wellbore proximate to a previously fractured region of the subterranean formation, and the first aqueous formulation can be allowed to contact the rock matrix of the subterranean formation for from one day to two weeks.

In some embodiments, the miscible solvent within the first aqueous formulation can be allowed to partition into hydrocarbons present within the subterranean formation for a period of time.

In some embodiments, the miscible solvent within the first aqueous formulation can be allowed to partition into hydrocarbons present within the subterranean formation for varying periods of time. In some examples, the miscible solvent can be allowed to partition into hydrocarbons present within the subterranean formation for at least one day (e.g., at least two days, at least three days, at least four days, at least five days, at least six days, at least one week, at least two weeks, at least three weeks, at least one month, at least two months, at least three months, at least four months, or at least five months). In some examples, the miscible solvent can be allowed to partition into hydrocarbons present within the subterranean formation for six months or less (e.g., five months or less, four months or less, three months or less, two months or less, one month or less, three weeks or less, two weeks or less, one week or less, six days or less, five days or less, four days or less, three days or less, or two days or less).

The miscible solvent can be allowed to partition into hydrocarbons present within the subterranean formation for a period of time ranging from any of the minimum values described above to any of the maximum values described above. For example, the miscible solvent can be allowed to partition into hydrocarbons present within the subterranean formation for from one day to six months (e.g., from one day to three months, from one day to one month, or from one day to two weeks).

In some embodiments, the subterranean formation can be a subterranean formation. In some embodiments, the subterranean formation can have a permeability of 10 millidarcy (mD) or less (e.g., 10 millidarcy (mD) or less, 5 millidarcy (mD) or less, 1 millidarcy (mD) or less, 0.5 millidarcy (mD) or less, 0.1 millidarcy (mD) or less, 0.05 mD or less, 0.01 mD or less, 5.0×10⁻³ mD or less, 1.0×10⁻³ mD or less, 5.0×10⁻⁴ mD or less, 1.0×10⁻⁴ mD or less, 5.0×10⁻⁵ mD or less, 1.0×10⁻⁵ mD or less, or 5.0×10⁻⁶ mD or less). In some embodiments, the subterranean formation can have a permeability of at least 1.0×10⁻⁶ mD (e.g., at least 5.0×10⁻⁶ mD, at least 1.0×10⁻⁵ mD, at least 5.0×10⁻⁵, at least 1.0×10⁻⁴ mD, at least 5.0×10⁻⁴, at least 1.0×10⁻³ mD, at least 5.0×10⁻³, at least 0.01, or at least 0.05).

The subterranean formation can have a permeability ranging from any of the minimum values described above to any of the maximum values described above. For example, in some embodiments, the subterranean formation can have a permeability of from 1.0×10⁻⁶ mD to less than 10 mD (e.g., from 1.0×10⁻⁶ mD to less than 10 mD, from 5.0×10⁻⁶ mD to 10 mD, from 1.0×10⁻⁵ mD to 10 mD, 5.0×10⁻⁵ mD to 10 mD, from 1.0×10⁻⁴ mD to 10 mD, 5.0×10⁻⁴ mD to 10 mD, from 1.0×10⁻³ mD to 10 mD, 5.0×10⁻³ mD to 10 mD, from 0.01 mD to 10 mD, from 0.05 mD to 10 mD, from 0.1 mD to 10 mD, from 0.5 mD to 10 mD, from 1 mD to 10 mD, from 2.5 mD to 10 mD, from 5 mD to 10 mD, from 7.5 mD to 10 mD, 1.0×10⁻⁶ mD to less than 5 mD, from 5.0×10⁻⁶ mD to 5 mD, from 1.0×10⁻⁵ mD to 5 mD, 5.0×10⁻⁵ mD to 5 mD, from 1.0×10⁻⁴ mD to 5 mD, 5.0×10⁻⁴ mD to 5 mD, from 1.0×10⁻³ mD to 5 mD, 5.0×10⁻³ mD to 5 mD, from 0.01 mD to 5 mD, from 0.05 mD to 5 mD, from 0.1 mD to 5 mD, from 0.5 mD to 5 mD, from 1 mD to 5 mD, from 2.5 mD to 5 mD, 1.0×10⁻⁶ mD to less than 1 mD, from 5.0×10⁻⁶ mD to 1 mD, from 1.0×10⁻⁵ mD to 1 mD, 5.0×10⁻⁵ mD to 1 mD, from 1.0×10⁻⁴ mD to 1 mD, 5.0×10⁻⁴ mD to 1 mD, from 1.0×10⁻³ mD to 1 mD, 5.0×10⁻³ mD to 1 mD, from 0.01 mD to 1 mD, from 0.05 mD to 1 mD, from 0.1 mD to 1 mD, from 0.5 mD to 1 mD, from 1.0×10⁻⁶ mD to less than 0.1 mD, from 5.0×10⁻⁶ mD to 0.1 mD, from 1.0×10⁻⁵ mD to 0.1 mD, 5.0×10⁻⁵ mD to 0.1 mD, from 1.0×10⁻⁴ mD to 0.1 mD, 5.0×10⁻⁴ mD to 0.1 mD, from 1.0×10⁻³ mD to 0.1 mD, 5.0×10⁻³ mD to 0.1 mD, from 0.01 mD to 0.1 mD, 0.05 mD to 0.1 mD, from 1.0×10⁻⁶ mD to 0.05 mD, from 5.0×10⁻⁶ mD to 0.05 mD, from 1.0×10⁻⁵ mD to 0.05 mD, 5.0×10⁻⁵ mD to 0.05 mD, from 1.0×10⁻⁴ mD to 0.05 mD, from 5.0×10⁻⁴ mD to 0.05 mD, from 1.0×10⁻³ mD to 0.05 mD, 5.0×10⁻³ mD to 0.05 mD, from 0.01 mD to 0.05 mD, from 1.0×10⁻⁶ mD to 0.01 mD, from 5.0×10⁻⁶ mD to 0.01 mD, from 1.0×10⁻⁵ mD to 0.01 mD, from 5.0×10⁻⁵ mD to 0.01 mD, from 1.0×10⁻⁴ mD to 0.01 mD, 5.0×10⁻⁴ mD to 0.01 mD, from 1.0×10⁻³ mD to 0.01 mD, 5.0×10⁻³ mD to 0.01 mD, from 1.0×10⁻⁶ mD to 5.0×10⁻³ mD, from 5.0×10⁻⁶ mD to 5.0×10⁻³ mD, from 1.0×10⁻⁵ mD to 5.0×10⁻³ mD, 5.0×10⁻⁵ mD to 5.0×10⁻³ mD, from 1.0×10⁻⁴ mD to 5.0×10⁻³ mD, from 5.0×10⁻⁴ mD to 5.0×10⁻³ mD, from 1.0×10⁻³ mD to 5.0×10⁻³ mD, from 1.0×10⁻⁶ mD to 1.0×10⁻³ mD, from 5.0×10⁻⁶ mD to 1.0×10⁻³ mD, from 1.0×10⁻⁵ mD to 1.0×10⁻³ mD, from 5.0×10⁻⁵ mD to 1.0×10⁻³ mD, from 1.0×10⁻⁴ mD to 1.0×10⁻³ mD, 5.0×10⁻⁴ mD to 1.0×10⁻³ mD, from 1.0×10⁻⁶ mD to 5.0×10⁻⁴ mD, from 5.0×10⁻⁶ mD to 5.0×10⁻⁴ mD, from 1.0×10⁻⁵ mD to 5.0×10⁻⁴ mD, from 5.0×10⁻⁵ mD to 5.0×10⁻⁴ mD, from 1.0×10⁻⁶ mD to 1.0×10⁻⁴ mD, from 5.0×10⁻⁶ mD to 1.0×10⁻⁴ mD, from 1.0×10⁻⁵ mD to 1.0×10⁻⁴ mD, from 5.0×10⁻⁵ mD to 1.0×10⁻⁴ mD, from 1.0×10⁻⁶ mD to 5.0×10⁻⁵ mD, from 5.0×10⁻⁶ mD to 5.0×10⁻⁵ mD, from 1.0×10⁻⁵ mD to 5.0×10⁻⁵ mD, from 1.0×10⁻⁶ mD to 1.0×10⁻⁵ mD, from 5.0×10⁻⁶ mD to 1.0×10⁻⁵ mD, or from 1.0×10⁻⁶ mD to 5.0×10⁻⁶ mD).

In some embodiments, the subterranean formations can be a conventional subterranean formation.

Described herein are methods for hydrocarbon recovery from a subterranean formation, the method including: injecting a first aqueous formulation including a surfactant package, and a miscible solvent at a constant salinity into the subterranean formation via an injection wellbore in fluid communication with the subterranean formation; and producing fluids from the subterranean formation through a production wellbore.

Also, described herein are methods for improving hydrocarbon production from subterranean formation that include injecting a first aqueous formulation including a surfactant package, and a miscible solvent at a constant salinity into the subterranean formation via an injection wellbore in fluid communication with the subterranean formation; and producing fluids from the subterranean formation through a production wellbore. In some embodiments, the miscible solvent can be present in the first aqueous formulation in an effective amount such that, in the presence of formation fluids, the first aqueous formulation and the formation fluids passes through a Winsor type III phase, thereby providing ultra-low interfacial tension between oil and aqueous phases.

In some embodiments, the methods can further include injecting a second aqueous formulation including a surfactant package, and a miscible solvent at a constant salinity into the subterranean formation via the injection wellbore in fluid communication with the subterranean formation. In some embodiments, injecting the second aqueous formulation can take place after the injection of the first aqueous formulation. In some embodiments, the miscible solvent can be present in the second aqueous formulation in an effective amount to produce a type I microemulsions. In some embodiments, the miscible solvent can be present in the second aqueous formulation in a concentration lower than a concentration of a same miscible solvent in the first aqueous formulation.

Described herein are also method for hydrocarbon recovery from a subterranean formation, the method including: injecting a first aqueous formulation including surfactant package and a miscible solvent at a constant salinity into the subterranean formation via an injection wellbore in fluid communication with the subterranean formation, wherein the miscible solvent is present in the first aqueous formulation in an effective amount such that, in the presence of formation fluids, the first aqueous formulation and the formation fluids passes through a Winsor type III phase, thereby providing ultra-low interfacial tension between oil and aqueous phases; and producing fluids from the subterranean formation through a production wellbore.

In some embodiments, the method can further include injecting a second aqueous formulation including surfactant package, a miscible solvent, an aqueous polymer, or any combination thereof at a constant salinity into the subterranean formation via an injection wellbore in fluid communication with the subterranean formation. In some embodiments, the method can further include injecting a second aqueous formulation including surfactant package, a miscible solvent, and an aqueous polymer at a constant salinity into the subterranean formation via an injection wellbore in fluid communication with the subterranean formation. In some embodiments, the method can further include injecting a second aqueous formulation including surfactant package and a miscible solvent at a constant salinity into the subterranean formation via an injection wellbore in fluid communication with the subterranean formation. In some embodiments, the method can further include injecting a second aqueous formulation including a surfactant package at a constant salinity into the subterranean formation via an injection wellbore in fluid communication with the subterranean formation. In some embodiments, the method can further include injecting a second aqueous formulation including a miscible solvent at a constant salinity into the subterranean formation via an injection wellbore in fluid communication with the subterranean formation. In some embodiments, the method can further include injecting a second aqueous formulation including an aqueous polymer at a constant salinity into the subterranean formation via an injection wellbore in fluid communication with the subterranean formation. In some embodiments, the miscible solvent can be present in the second aqueous formulation in an effective amount to produce a type I microemulsions. In some embodiments, the miscible solvent can be present in the second aqueous formulation in a concentration lower than a concentration of a same miscible solvent in the first aqueous formulation.

In some embodiments, the methods can improve the hydrocarbon recovery by at least 10% (e.g., at least 15%, at least 20%, at least 25%, at least 30%, at least 35%, or at least 40%) relative to injection brine having a TDS of 50,000 ppm. In some embodiments, the methods can improve the hydrocarbon recovery by at least 25% relative to injection brine having a TDS of 50,000 ppm.

In some embodiments, the methods can further include preparing the first aqueous formulation. In some embodiments, the methods can further include preparing the second aqueous formulation. For example, in some embodiments, the methods can further include combining the miscible solvent described herein with a surfactant package described herein and optionally additional components to form the first aqueous formulations and/or the second aqueous formulation described herein.

In some cases, the subterranean formation can include fractures. These existing fractures can be naturally occurring fractures present within a formation. For example, in some embodiments, the formation can include naturally fractured carbonate or naturally fractured sandstone. The presence or absence of naturally occurring fractures within a subterranean formation can be assessed using standard methods known in the art, including seismic surveys, geology, outcrops, cores, logging, reservoir characterization including preparing grids, etc. In other embodiments, the formation can include fractures generated by a fracturing operation.

In some embodiments, the subterranean formation can have a temperature of at least 75° F. (e.g., at least 80° F., at least 85° F., at least 90° F., at least 95° F., at least 100° F., at least 105° F., at least 110° F., at least 115° F., at least 120° F., at least 125° F., at least 130° F., at least 135° F., at least 140° F., at least 145° F., at least 150° F., at least 155° F., at least 160° F., at least 165° F., at least 170° F., at least 175° F., at least 180° F., at least 190° F., at least 200° F., at least 205° F., at least 210° F., at least 215° F., at least 220° F., at least 225° F., at least 230° F., at least 235° F., at least 240° F., at least 245° F., at least 250° F., at least 255° F., at least 260° F., at least 265° F., at least 270° F., at least 275° F., at least 280° F., at least 285° F., at least 290° F., at least 295° F., at least 300° F., at least 305° F., at least 310° F., at least 315° F., at least 320° F., at least 325° F., at least 330° F., at least 335° F., at least 340° F., or at least 345° F.). In some embodiments, the subterranean formation can have a temperature of 350° F. or less (e.g., 345° F. or less, 340° F. or less, 335° F. or less, 330° F. or less, 325° F. or less, 320° F. or less, 315° F. or less, 310° F. or less, 305° F. or less, 300° F. or less, 295° F. or less, 290° F. or less, 285° F. or less, 280° F. or less, 275° F. or less, 270° F. or less, 265° F. or less, 260° F. or less, 255° F. or less, 250° F. or less, 245° F. or less, 240° F. or less, 235° F. or less, 230° F. or less, 225° F. or less, 220° F. or less, 215° F. or less, 210° F. or less, 205° F. or less, 200° F. or less, 195° F. or less, 190° F. or less, 185° F. or less, 180° F. or less, 175° F. or less, 170° F. or less, 165° F. or less, 160° F. or less, 155° F. or less, 150° F. or less, 145° F. or less, 140° F. or less, 135° F. or less, 130° F. or less, 125° F. or less, 120° F. or less, 115° F. or less, 110° F. or less, 105° F. or less, 100° F. or less, 95° F. or less, 90° F. or less, 85° F. or less, or 80° F. or less).

The subterranean formation can have a temperature ranging from any of the minimum values described above to any of the maximum values described above. For example, in some embodiments, the subterranean formation can have a temperature of from 75° F. to 350° F. (approximately 24° C. to 176° C.), from 130° F. to 250° F. (approximately 54° C. to 121° C.), from 100° F. to 250° F. (approximately 38° C. to 121° C.), from 150° F. to 180° F. (approximately 66° C. to 82° C.), from 150° F. to 250° F. (approximately 66° C. to 121° C.), from 150° F. to 250° F. (approximately 66° C. to 121° C.), from 110° F. to 350° F. (approximately 43° C. to 176° C.), from 110° F. to 150° F. (approximately 43° C. to 66° C.), from 150° F. to 200° F. (approximately 66° C. to 93° C.), from 200° F. to 250° F. (approximately 93° C. to 121° C.), from 250° F. to 300° F. (approximately 121° C. to 149° C.), from 300° F. to 350° F. (approximately 149° C. to 176° C.), from 110° F. to 240° F. (approximately 43° C. to 116° C.), or from 240° F. to 350° F. (approximately 116° C. to 176° C.).

In some embodiments, the salinity of subterranean formation can be at least 5,000 ppm TDS (e.g., at least 25,000 ppm TDS, at least 50,000 ppm TDS, at least 75,000 ppm TDS, at least 100,000 ppm TDS, at least 125,000 ppm TDS, at least 150,000 ppm TDS, at least 175,000 ppm TDS, at least 200,000 ppm TDS, at least 225,000 ppm TDS, at least 250,000 ppm TDS, or at least 275,000 ppm TDS). In some embodiments, the salinity of subterranean formation can be 300,000 ppm TDS or less (e.g., 275,000 ppm TDS or less, 250,000 ppm TDS or less, 225,000 ppm TDS or less, 200,000 ppm TDS or less, 175,000 ppm TDS or less, 150,000 ppm TDS or less, 125,000 ppm TDS or less, 100,000 ppm TDS or less, 75,000 ppm TDS or less, 50,000 ppm TDS or less, or 25,000 ppm TDS or less).

The salinity of subterranean formation can range from any of the minimum values described above to any of the maximum values described above. For example, in some embodiments, the salinity of subterranean formation can be from 5,000 ppm TDS to 300,000 ppm TDS (e.g., from 5,000 ppm TDS to 300,000 ppm TDS, from 30,000 ppm TDS to 300,000 ppm TDS, from 30,000 ppm TDS to 220,000 ppm TDS, or from 100,000 ppm to 300,000 ppm TDS).

In some embodiments, the subterranean formation can be oil-wet. In some embodiments, the subterranean formation can be water-wet. In some embodiments, the subterranean formation can be mixed-wet.

In some embodiments, the first aqueous formulation and/or the second aqueous formulation can be introduced at a wellhead pressure of at least 200 PSI (e.g., at least 250 PSI, at least 500 PSI, at least 750 PSI, at least 1000 PSI, at least 1500 PSI, at least 2000 PSI, at least 2500 PSI, at least 3000 PSI, at least 3500 PSI, at least 4000 PSI, at least 4500 PSI, at least 5000 PSI, at least 5500 PSI, at least 6000 PSI, at least 6500 PSI, at least 7000 PSI, at least 7500 PSI, at least 8000 PSI, at least 8500 PSI, at least 9000 PSI, or at least 9500 PSI). In some embodiments, the first aqueous formulation and/or the second aqueous formulation can be introduced at a wellhead pressure of 10,000 PSI or less (e.g., 9,000 PSI or less, 8,000 PSI or less, 7,000 PSI or less, 6,000 PSI or less, 5,000 PSI or less, 4,000 PSI or less, 3,000 PSI or less, 2,000 PSI or less, 1,000 PSI or less, 500 PSI or less, or 250 PSI or less).

The first aqueous formulation and/or the second aqueous formulation can be introduced at a wellhead pressure ranging from any of the minimum values described above to any of the maximum values described above. For example, in some embodiments, first aqueous formulation and/or the second aqueous formulation can be introduced at a wellhead pressure of from 200 PSI to 10,000 PSI (e.g. from 200 PSI to 9,000 PSI, from 200 PSI to 8,000 PSI, from 200 PSI to 7,000 PSI, from 200 PSI to 6,000 PSI, from 200 PSI to 5,000 PSI, from 200 PSI to 4,000 PSI, from 200 PSI to 3,000 PSI, from 200 PSI to 2,000 PSI, from 200 PSI to 1,000 PSI, from 200 PSI to 500 PSI, from 500 PSI to 10,000 PSI, from 500 PSI to 9,000 PSI, from 500 PSI to 8,000 PSI, from 500 PSI to 7,000 PSI, from 500 PSI to 6,000 PSI, from 500 PSI to 5,000 PSI, from 500 PSI to 4,000 PSI, from 500 PSI to 3,000 PSI, from 500 PSI to 2,000 PSI, from 500 PSI to 1,000 PSI, from 1000 PSI to 10,000 PSI, from 1000 PSI to 9,000 PSI, from 1000 PSI to 8,000 PSI, from 1,000 PSI to 7,000 PSI, from 1,000 PSI to 6,000 PSI, from 1,000 PSI to 5,000 PSI, from 1,000 PSI to 4,000 PSI, from 1,000 PSI to 3,000 PSI, from 1,000 PSI to 2,000 PSI, from 2000 PSI to 10,000 PSI, from 2,000 PSI to 9,000 PSI, from 2,000 PSI to 8,000 PSI, from 2,000 PSI to 7,000 PSI, from 2,000 PSI to 6,000 PSI, from 2,000 PSI to 5,000 PSI, from 2,000 PSI to 4,000 PSI, from 2,000 PSI to 3,000 PSI, from 3,000 PSI to 10,000 PSI, from 3,000 PSI to 9,000 PSI, from 3,000 PSI to 8,000 PSI, from 3,000 PSI to 7,000 PSI, from 3,000 PSI to 6,000 PSI, from 3,000 PSI to 5,000 PSI, from 3,000 PSI to 4,000 PSI, from 4,000 PSI to 10,000 PSI, from 4,000 PSI to 9,000 PSI, from 4,000 PSI to 8,000 PSI, from 4,000 PSI to 7,000 PSI, from 4,000 PSI to 6,000 PSI, from 4,000 PSI to 5,000 PSI, from 5,000 PSI to 10,000 PSI, from 5,000 PSI to 9,000 PSI, from 5,000 PSI to 8,000 PSI, from 5,000 PSI to 7,000 PSI, from 5,000 PSI to 6,000 PSI, from 6,000 PSI to 10,000 PSI, from 6,000 PSI to 9,000 PSI, from 6,000 PSI to 8,000 PSI, from 6,000 PSI to 7,000 PSI, from 7,000 PSI to 10,000 PSI, from 7,000 PSI to 9,000 PSI, from 7,000 PSI to 8,000 PSI, from 8,000 PSI to 10,000 PSI, from 8,000 PSI to 9,000 PSI, or from 9,000 PSI to 10,000 PSI).

In some embodiments, the hydrocarbons present within the subterranean formation can include light oil. In some embodiments, the light oil can have an API gravity of at least 40 (e.g., at least 45, at least 50, or at least 55). In some embodiments, the light oil can have an API gravity of 60 or less (e.g., 55 or less, 50 or less, or 45 or less).

The light oil can have an API gravity ranging from any of the minimum values described above to any of the maximum values described above. For example, in some embodiments, the light oil can have an API gravity of from 40 to 60 (e.g., from 40 to 45, from 40 to 50, from 40 to 55, from 45 to 50, from 45 to 55, from 45 to 60, from 50 to 55, from 50 to 60, or from 55 to 60).

In some embodiments, the hydrocarbons present within the subterranean formation can include heavy oil. In some embodiments, the heavy oil can have an API gravity of at least 10 (e.g., at least 20, or at least 30). In some embodiments, the heavy oil can have an API gravity of 25 or less (e.g., 20 or less, or 15 or less).

The heavy oil can have an API gravity ranging from any of the minimum values described above to any of the maximum values described above. For example, in some embodiments, the light oil can have an API gravity of from 10 to 25 (e.g., from 10 to 20, from 10 to 15, from 15 to 25, from 15 to 20, or from 20 to 25).

In some embodiments, the first aqueous formulation can be injected in an effective amount to reduce the viscosity of the hydrocarbons present within the subterranean formation by at least 1% (e.g., at least 5%, at least 10%, at least 20%, at least 30%, or at least 40%).

In some embodiments, the first aqueous formulation can be injected in an effective amount to reduce the viscosity of the hydrocarbons present within the subterranean formation by 50% or less (e.g., 40% or less, 30% or less, 20% or less, 10% or less, or 5% or less).

The first aqueous formulation can be injected in an effective amount to reduce the viscosity of the hydrocarbons present within the subterranean formation ranging from any of the minimum values described above to any of the maximum values described above. For example, in some embodiments, the first aqueous formulation can be injected in an effective amount to reduce the viscosity of the hydrocarbons present within the subterranean formation by from 1% to 50% (e.g., from 1% to 40%, from 1% to 30%, from 1% to 20%, from 1% to 10%, from 1% to 5%, from 5% to 50%, from 5% to 40%, from 5% to 30%, from 5% to 20%, from 5% to 10%, from 10% to 50%, from 10% to 40%, from 10% to 30%, from 10% to 20%, from 25% to 50%, from 25% to 40%, from 25% to 30%, from 30% to 50%, from 30% to 40%, or from 40% to 50%).

In some embodiments, the first aqueous formulation can have an interfacial tension of 0.1 dynes/cm or less (e.g., from 0.001 to 0.01 dynes/cm) with a hydrocarbon phase present in the subterranean formation.

In some embodiments, the first aqueous formulation can have an interfacial tension of at least 0.001 dynes/cm (e.g., at least 0.002 dynes/cm, at least 0.003 dynes/cm, at least 0.004 dynes/cm, at least 0.005 dynes/cm, at least 0.006 dynes/cm, at least 0.007 dynes/cm, at least 0.008 dynes/cm, or at least 0.009 dynes/cm).

In some embodiments, the first aqueous formulation can have an interfacial tension of 0.01 dynes/cm or less (e.g., 0.009 dynes/cm or less, 0.008 dynes/cm or less, 0.007 dynes/cm or less, 0.006 dynes/cm or less, 0.005 dynes/cm or less, 0.004 dynes/cm or less, 0.003 dynes/cm or less, or 0.002 dynes/cm or less).

The first aqueous formulation can have an interfacial tension ranging from any of the minimum values described above to any of the maximum values described above. For example, in some embodiments, the first aqueous formulation can have an interfacial tension of from 0.001 to 0.01 dynes/cm (e.g., from 0.001 to 0.002 dynes/cm, from 0.001 to 0.005 dynes/cm, from 0.001 to 0.007 dynes/cm, from 0.002 to 0.005 dynes/cm, from 0.002 to 0.007 dynes/cm, from 0.002 to 0.01 dynes/cm, from 0.005 to 0.007 dynes/cm, from 0.005 to 0.01 dynes/cm, or from 0.007 to 0.01 dynes/cm) with a hydrocarbon phase present in the subterranean formation.

In some embodiments, when the miscible solvent is present the second aqueous formulation can have an interfacial tension of at least 0.001 dynes/cm (e.g., at least 0.002 dynes/cm, at least 0.003 dynes/cm, at least 0.004 dynes/cm, at least 0.005 dynes/cm, at least 0.006 dynes/cm, at least 0.007 dynes/cm, at least 0.008 dynes/cm, or at least 0.009 dynes/cm).

In some embodiments, when the miscible solvent is present the second aqueous formulation can have an interfacial tension of 0.01 dynes/cm or less (e.g., 0.009 dynes/cm or less, 0.008 dynes/cm or less, 0.007 dynes/cm or less, 0.006 dynes/cm or less, 0.005 dynes/cm or less, 0.004 dynes/cm or less, 0.003 dynes/cm or less, or 0.002 dynes/cm or less).

When the miscible solvent is present the second aqueous formulation can have an interfacial tension ranging from any of the minimum values described above to any of the maximum values described above. For example, in some embodiments, when the miscible solvent is present the second aqueous formulation can have an interfacial tension of from 0.001 to 0.01 dynes/cm (e.g., from 0.001 to 0.002 dynes/cm, from 0.001 to 0.005 dynes/cm, from 0.001 to 0.007 dynes/cm, from 0.002 to 0.005 dynes/cm, from 0.002 to 0.007 dynes/cm, from 0.002 to 0.01 dynes/cm, from 0.005 to 0.007 dynes/cm, from 0.005 to 0.01 dynes/cm, or from 0.007 to 0.01 dynes/cm) with a hydrocarbon phase present in the subterranean formation.

In some embodiments, the first aqueous formulation can be injected in an effective amount to reduce microemulsion viscosity by at least 5% (e.g., at least 10%, at least 15%, at least 20%, at least 25%, at least 30%, at least 35%, at least 40%, or at least 45%).

In some embodiments, the first aqueous formulation can be injected in an effective amount to reduce microemulsion viscosity by 50% or less (e.g., 45% or less, 40% or less, 35% or less, 30% or less, 25% or less, 20% or less, 15% or less, or 10% or less).

In some embodiments, the first aqueous formulation can be injected in an effective amount to reduce microemulsion viscosity by from 5% to 50% (e.g., from 5% to 10%, from 5% to 20%, from 5% to 25%, from 5% to 30%, from 5% to 35%, from 5% to 40%, from 5% to 45%, from 10% to 20%, from 10% to 25%, from 10% to 30%, from 10% to 35%, from 10% to 40%, from 10% to 45%, from 10% to 50%, from 20% to 25%, from 20% to 30%, from 20% to 35%, from 20% to 40%, from 20% to 45%, from 20% to 50%, from 30% to 35%, from 30% to 40%, from 30% to 45%, from 30% to 50%, from 40% to 45%, or from 40% to 50%) relative to relative to the same aqueous formulation without a miscible solvent.

In some embodiments, the surfactant package can be present in the first aqueous formulation in a concentration of at least 0.01% by weight (e.g., at least 0.05% by weight, at least 0.075% by weight, at least 0.1% by weight, at least 0.25% by weight, at least 0.5% by weight, at least 0.75% by weight, at least 1% by weight, at least 2.5% by weight, at least 5% by weight, at least 10% by weight, or at least 15% by weight), based on the total weight of the first aqueous formulation.

In some embodiments, the surfactant package can be present in the first aqueous formulation in a concentration of 20% by weight or less (e.g., 15% by weight or less, 10% by weight or less, 5% by weight or less, 2.5% by weight or less, 1% by weight or less, 0.75% by weight or less, 0.5% by weight or less, 0.25% by weight or less, 0.1% by weight or less, 0.075% by weight or less, 0.05% by weight or less, or 0.025% by weight or less), based on the total weight of the first aqueous formulation.

The surfactant package can be present in the first aqueous formulation in a concentration ranging from any of the minimum values described above. For example, in some embodiments, the surfactant package can be present in the first aqueous formulation in a concentration of from 0.01% by weight to 20% by weight (e.g., from 0.01% to 1% by weight, from 0.01% to 0.75% by weight, from 0.01% to 0.5% by weight, from 0.01% to 0.25% by weight, from 0.01% to 0.1% by weight, from 0.01% to 0.075% by weight, from 0.01% to 0.05% by weight, from 0.01% to 0.025% by weight, from 1% to 15% by weight, from 1% to 10% by weight, from 5% to 20% by weight, from 5% to 15% by weight, from 5% to 10% by weight, from 10% to 20% by weight, from 10% to 15% by weight, or from 15% to 20% by weight), based on the total weight of the first aqueous formulation.

In some embodiments, when present the surfactant package can be present in the second aqueous formulation in a concentration of at least 0.01% by weight (e.g., at least 0.05% by weight, at least 0.075% by weight, at least 0.1% by weight, at least 0.25% by weight, at least 0.5% by weight, at least 0.75% by weight, at least 1% by weight, at least 2.5% by weight, at least 5% by weight, at least 10% by weight, or at least 15% by weight), based on the total weight of the second aqueous formulation.

In some embodiments, when present the surfactant package can be present in the second aqueous formulation in a concentration of 20% by weight or less (e.g., 15% by weight or less, 10% by weight or less, 5% by weight or less, 2.5% by weight or less, 1% by weight or less, 0.75% by weight or less, 0.5% by weight or less, 0.25% by weight or less, 0.1% by weight or less, 0.075% by weight or less, 0.05% by weight or less, or 0.025% by weight or less), based on the total weight of the second aqueous formulation.

The surfactant package can be present in the second aqueous formulation in a concentration ranging from any of the minimum values described above. For example, in some embodiments, the surfactant package can be present in the second aqueous formulation in a concentration of from 0% by weight to 20% by weight (e.g., from 0% to 1% by weight, from 0% to 0.75% by weight, from 0% to 0.5% by weight, from 0% to 0.25% by weight, from 0% to 0.1% by weight, from 0% to 0.075% by weight, from 0% to 0.05% by weight, from 0% to 0.025% by weight, from 0.01% to 1% by weight, from 0.01% to 0.75% by weight, from 0.01% to 0.5% by weight, from 0.01% to 0.25% by weight, from 0.01% to 0.1% by weight, from 0.01% to 0.075% by weight, from 0.01% to 0.05% by weight, from 0.01% to 0.025% by weight, from 1% to 15% by weight, from 1% to 10% by weight, from 5% to 20% by weight, from 5% to 15% by weight, from 5% to 10% by weight, from 10% to 20% by weight, from 10% to 15% by weight, or from 15% to 20% by weight), based on the total weight of the second aqueous formulation.

In some embodiments, the surfactant package can include an anionic surfactant, a non-ionic surfactant, a zwitterionic surfactant, or any combination thereof. In some embodiments, the surfactant package can include a non-ionic surfactant, an anionic surfactant, or any combination thereof.

In some embodiments, the surfactant package can further include co-surfactants. In some embodiments, the co-surfactants can include an anionic surfactant, a non-ionic surfactant, a zwitterionic surfactant, or any combination thereof.

In some embodiments, the hydrophilic-lipophilic balance (HLB) of the non-ionic surfactant is greater than 10 (e.g., greater than 9, greater than 8, or greater than 7). In some embodiments, the HLB of the non-ionic surfactant is from 7 to 10.

The non-ionic surfactant can include a hydrophobic tail comprising from 6 to 60 carbon atoms. In some embodiments, the non-ionic surfactant can include a hydrophobic tail that can include at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, at least 39 carbon atoms, at least 40 carbon atoms, at least 41 carbon atoms, at least 42 carbon atoms, at least 43 carbon atoms, at least 44 carbon atoms, at least 45 carbon atoms, at least 46 carbon atoms, at least 47 carbon atoms, at least 48 carbon atoms, at least 49 carbon atoms, at least 50 carbon atoms, at least 51 carbon atoms, at least 52 carbon atoms, at least 53 carbon atoms, at least 54 carbon atoms, at least 55 carbon atoms, at least 56 carbon atoms, at least 57 carbon atoms, at least 58 carbon atoms, or at least 59 carbon atoms). In some embodiments, the non-ionic surfactant can include a hydrophobic tail that includes 60 carbon atoms or less (e.g., 59 carbon atoms or less, 58 carbon atoms or less, 57 carbon atoms or less, 56 carbon atoms or less, 55 carbon atoms or less, 54 carbon atoms or less, 53 carbon atoms or less, 52 carbon atoms or less, 51 carbon atoms or less, 50 carbon atoms or less, 49 carbon atoms or less, 48 carbon atoms or less, 47 carbon atoms or less, 46 carbon atoms or less, 45 carbon atoms or less, 44 carbon atoms or less, 43 carbon atoms or less, 42 carbon atoms or less, 41 carbon atoms or less, 40 carbon atoms or less, 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The non-ionic surfactant can include a hydrophobic tail that includes a number of carbon atoms ranging from any of the minimum values described above to any of the maximum values described above. For example, the non-ionic surfactant can include a hydrophobic tail including from 6 to 15, from 16 to 30, from 31 to 45, from 46 to 60, from 6 to 25, from 26 to 60, from 6 to 30, from 31 to 60, from 6 to 32, from 33 to 60, from 6 to 12, from 13 to 22, from 23 to 32, from 33 to 42, from 43 to 52, from 53 to 60, from 6 to 10, from 10 to 15, from 11 to 15, from 16 to 25, from 26 to 35, or from 36 to 45 carbon atoms. In some cases, the hydrophobic tail may be a straight chain, branched chain, and/or may include cyclic structures. The hydrophobic carbon tail may include single bonds, double bonds, triple bonds, or any combination thereof. In some cases, the hydrophobic tail can include an alkyl group, with or without an aromatic ring (e.g., a phenyl ring) attached to it. In some embodiments, the hydrophobic tail can include a branched hydrophobic tail derived from Guerbet alcohols.

Example non-ionic surfactants include alkyl aryl alkoxy alcohols, alkyl alkoxy alcohols, or any combination thereof. In embodiments, the non-ionic surfactant may be a mix of surfactants with different length lipophilic tail chain lengths. For example, the non-ionic surfactant may be C9-C11:9EO, which indicates a mixture of non-ionic surfactants that have a lipophilic tail length of 9 carbon to 11 carbon, which is followed by a chain of 9 EOs. The hydrophilic moiety is an alkyleneoxy chain (e.g., an ethoxy (EO), butoxy (BO) and/or propoxy (PO) chain with two or more repeating units of EO, BO, and/or PO). In some embodiments, 1-100 repeating units of EO are present. In some embodiments, 0-65 repeating units of PO are present. In some embodiments, 0-25 repeating units of BO are present. For example, the non-ionic surfactant could include 10EO:5PO or 5EO. In embodiments, the non-ionic surfactant may be a mix of surfactants with different length lipophilic tail chain lengths. For example, the non-ionic surfactant may be C9-C11:PO9:EO2, which indicates a mixture of non-ionic surfactants that have a lipophilic tail length of 9 carbon to 11 carbon, which is followed by a chain of 9 POs and 2 EOs. In specific embodiments, the non-ionic surfactant is linear C9-C11:9EO. In some embodiments, the non-ionic surfactant is a Guerbet PO(0-65) and EO(0-100) (Guerbet can be C6-C36); or alkyl PO(0-65) and EO(0-100): where the alkyl group is linear or branched C1-C36. In some examples, the non-ionic surfactant can include a branched or unbranched C6-C32:PO(0-65):EO(0-100) (e.g., a branched or unbranched C6-C30:PO(30-40):EO(25-35), a branched or unbranched C6-C12:PO(30-40):EO(25-35), a branched or unbranched C6-30:EO(8-30), a branched or unbranched C11-15:EO(30-50), a branched or unbranched C11-15:EO(35-45), a branched or unbranched C16:22:EO(20-30), a branched or unbranched C16:22:EO(30-50), a branched or unbranched C16:22:EO(35-45), a branched or unbranched C22-30:EO(30-40):EO(25-35), or any combination thereof). In some embodiments, the non-ionic surfactant is one or more alkyl polyglucosides.

Suitable anionic surfactants can include a hydrophobic tail that includes from 6 to 60 carbon atoms. In some embodiments, the anionic surfactant can include a hydrophobic tail that includes at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, at least 39 carbon atoms, at least 40 carbon atoms, at least 41 carbon atoms, at least 42 carbon atoms, at least 43 carbon atoms, at least 44 carbon atoms, at least 45 carbon atoms, at least 46 carbon atoms, at least 47 carbon atoms, at least 48 carbon atoms, at least 49 carbon atoms, at least 50 carbon atoms, at least 51 carbon atoms, at least 52 carbon atoms, at least 53 carbon atoms, at least 54 carbon atoms, at least 55 carbon atoms, at least 56 carbon atoms, at least 57 carbon atoms, at least 58 carbon atoms, or at least 59 carbon atoms). In some embodiments, the anionic surfactant can include a hydrophobic tail that includes 60 carbon atoms or less (e.g., 59 carbon atoms or less, 58 carbon atoms or less, 57 carbon atoms or less, 56 carbon atoms or less, 55 carbon atoms or less, 54 carbon atoms or less, 53 carbon atoms or less, 52 carbon atoms or less, 51 carbon atoms or less, 50 carbon atoms or less, 49 carbon atoms or less, 48 carbon atoms or less, 47 carbon atoms or less, 46 carbon atoms or less, 45 carbon atoms or less, 44 carbon atoms or less, 43 carbon atoms or less, 42 carbon atoms or less, 41 carbon atoms or less, 40 carbon atoms or less, 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The anionic surfactant can include a hydrophobic tail that includes a number of carbon atoms ranging from any of the minimum values described above to any of the maximum values described above. For example, in some embodiments, the anionic surfactant can include a hydrophobic tail including from 6 to 15, from 16 to 30, from 31 to 45, from 46 to 60, from 6 to 25, from 26 to 60, from 6 to 30, from 31 to 60, from 6 to 32, from 33 to 60, from 6 to 12, from 13 to 22, from 23 to 32, from 33 to 42, from 43 to 52, from 53 to 60, from 6 to 10, from 10 to 15, from 16 to 25, from 26 to 35, or from 36 to 45 carbon atoms. The hydrophobic (lipophilic) carbon tail may be a straight chain, branched chain, and/or may include cyclic structures. The hydrophobic carbon tail may include single bonds, double bonds, triple bonds, or any combination thereof. In some embodiments, the anionic surfactant can include a branched hydrophobic tail derived from Guerbet alcohols. The hydrophilic portion of the anionic surfactant can include, for example, one or more sulfate moieties (e.g., one, two, or three sulfate moieties), one or more sulfonate moieties (e.g., one, two, or three sulfonate moieties), one or more sulfosuccinate moieties (e.g., one, two, or three sulfosuccinate moieties), one or more carboxylate moieties (e.g., one, two, or three carboxylate moieties), or any combination thereof.

In some embodiments, the anionic surfactant can include, for example a sulfonate, a disulfonate, a polysulfonate, a sulfate, a disulfate, a polysulfate, a sulfosuccinate, a disulfosuccinate, a polysulfosuccinate, a carboxylate, a dicarboxylate, a polycarboxylate, or any combination thereof. In some examples, the anionic surfactant can include an internal olefin sulfonate (IOS), an isomerized olefin sulfonate, an alfa olefin sulfonate (AOS), an alkyl aryl sulfonate (AAS), a xylene sulfonate, an alkane sulfonate, a petroleum sulfonate, an alkyl diphenyl oxide (di)sulfonate, an alcohol sulfate, an alkoxy sulfate, an alkoxy sulfonate, an alkoxy carboxylate, an alcohol phosphate, or an alkoxy phosphate. In some embodiments, the anionic surfactant can include an alkoxy carboxylate surfactant, an alkoxy sulfate surfactant, an alkoxy sulfonate surfactant, an alkyl sulfonate surfactant, an aryl sulfonate surfactant, or an olefin sulfonate surfactant.

An “alkoxy carboxylate surfactant” or “alkoxy carboxylate” refers to a compound having an alkyl or aryl attached to one or more alkoxylene groups (typically —CH₂—CH(ethyl)-O—, —CH₂—CH(methyl)-O—, or —CH₂—CH₂—O—) which, in turn is attached to —COO⁻ or acid or salt thereof including metal cations such as sodium. In embodiments, the alkoxy carboxylate surfactant can be defined by the formulae below:

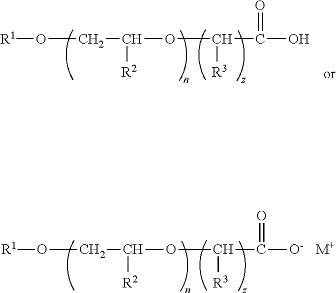

wherein R¹ is substituted or unsubstituted C6-C36 alkyl or substituted or unsubstituted aryl; R² is, independently for each occurrence within the compound, hydrogen or unsubstituted C₁-C₆ alkyl; R³ is independently hydrogen or unsubstituted C₁-C₆ alkyl, n is an integer from 0 to 175, z is an integer from 1 to 6 and M⁺ is a monovalent, divalent or trivalent cation. In some of these embodiments, R¹ can be an unsubstituted linear or branched C6-C36 alkyl.

In certain embodiments, the alkoxy carboxylate can be a C6-C32:PO(0-65):EO(0-100)-carboxylate (i.e., a C6-C32 hydrophobic tail, such as a branched or unbranched C6-C32 alkyl group, attached to from 0 to 65 propyleneoxy groups (—CH2-CH(methyl)-O— linkers), attached in turn to from 0 to 100 ethyleneoxy groups (—CH2-CH2-O— linkers), attached in turn to —COO— or an acid or salt thereof including metal cations such as sodium). In certain embodiments, the alkoxy carboxylate can be a branched or unbranched C6-C30:PO(30-40):EO(25-35)-carboxylate. In certain embodiments, the alkoxy carboxylate can be a branched or unbranched C6-C12:PO(30-40):EO(25-35)-carboxylate. In certain embodiments, the alkoxy carboxylate can be a branched or unbranched C6-C30:EO(8-30)-carboxylate.

An “alkoxy sulfate surfactant” or “alkoxy sulfate” refers to a surfactant having an alkyl or aryl attached to one or more alkoxylene groups (typically —CH2-CH(ethyl)-O—, —CH2-CH(methyl)-O—, or —CH2-CH2-O—) which, in turn is attached to —SO3- or acid or salt thereof including metal cations such as sodium. In some embodiment, the alkoxy sulfate surfactant has the formula R—(BO)e-(PO)f-(EO)g-SO3- or acid or salt (including metal cations such as sodium) thereof, wherein R is C6-C32 alkyl, BO is —CH2-CH(ethyl)-O—, PO is —CH2-CH(methyl)-O—, and EO is —CH2-CH2-O—. The symbols e, f and g are integers from 0 to 50 wherein at least one is not zero.

In embodiments, the alkoxy sulfate surfactant can be an aryl alkoxy sulfate surfactant. The aryl alkoxy surfactant can be an alkoxy surfactant having an aryl attached to one or more alkoxylene groups (typically —CH2-CH(ethyl)-O—, —CH2-CH(methyl)-O—, or —CH2-CH2-O—) which, in turn is attached to —SO3- or acid or salt thereof including metal cations such as sodium.

An “alkyl sulfonate surfactant” or “alkyl sulfonate” refers to a compound that includes an alkyl group (e.g., a branched or unbranched C6-C32 alkyl group) attached to —SO3- or acid or salt thereof including metal cations such as sodium.

An “aryl sulfate surfactant” or “aryl sulfate” refers to a compound having an aryl group attached to —O—SO3- or acid or salt thereof including metal cations such as sodium. An “aryl sulfonate surfactant” or “aryl sulfonate” refers to a compound having an aryl group attached to —SO3- or acid or salt thereof including metal cations such as sodium. In some cases, the aryl group can be substituted, for example, with an alkyl group (an alkyl aryl sulfonate).

An “internal olefin sulfonate,” “isomerized olefin sulfonate,” or “IOS” refers to an unsaturated hydrocarbon compound comprising at least one carbon-carbon double bond and at least one SO3- group, or a salt thereof. As used herein, a “C20-C28 internal olefin sulfonate,” “a C20-C28 isomerized olefin sulfonate,” or “C20-C28 IOS” refers to an IOS, or a mixture of IOSs with an average carbon number of 20 to 28, or of 23 to 25. The C20-C28 IOS may include at least 80% of IOS with carbon numbers of 20 to 28, at least 90% of IOS with carbon numbers of 20 to 28, or at least 99% of IOS with carbon numbers of 20 to 28. As used herein, a “C15-C18 internal olefin sulfonate,” “C15-C18 isomerized olefin sulfonate,” or “C15-C18 IOS” refers to an IOS or a mixture of IOSs with an average carbon number of 15 to 18, or of 16 to 17. The C15-C18 IOS may include at least 80% of IOS with carbon numbers of 15 to 18, at least 90% of IOS with carbon numbers of 15 to 18, or at least 99% of IOS with carbon numbers of 15 to 18. The internal olefin sulfonates or isomerized olefin sulfonates may be alpha olefin sulfonates, such as an isomerized alpha olefin sulfonate. The internal olefin sulfonates or isomerized olefin sulfonates may also include branching. In certain embodiments, C15-18 IOS may be added to the surfactant package when the injection fluid is intended for use in high temperature unconventional subterranean formations, such as formations above 130° F. (approximately 55° C.). The IOS may be at least 20% branching, 30% branching, 40% branching, 50% branching, 60% branching, or 65% branching. In some embodiments, the branching is between 20-98%, 30-90%, 40-80%, or around 65%. Examples of internal olefin sulfonates and the methods to make them are found in U.S. Pat. No. 5,488,148, U.S. Patent Application Publication 2009/0112014, and SPE 129766, all incorporated herein by reference.

In embodiments, the anionic surfactant can be a disulfonate, alkyldiphenyloxide disulfonate, mono alkyldiphenyloxide disulfonate, di alkyldiphenyloxide disulfonate, or a di alkyldiphenyloxide monosulfonate, where the alkyl group can be a C6-C36 linear or branched alkyl group. In embodiments, the anionic surfactant can be an alkylbenzene sulfonate or a dibenzene disufonate. In embodiments, the anionic surfactant can be benzenesulfonic acid, decyl(sulfophenoxy)-disodium salt; linear or branched C6-C36 alkyl:PO(0-65):EO(0-100) sulfate; or linear or branched C6-C36 alkyl:PO(0-65):EO(0-100) carboxylate. In embodiments, the anionic surfactant is an isomerized olefin sulfonate (C6-C30), internal olefin sulfonate (C6-C30) or internal olefin disulfonate (C6-C30). In some embodiments, the anionic surfactant is a Guerbet-PO(0-65)-EO(0-100) sulfate (Guerbet portion can be C6-C36). In some embodiments, the anionic surfactant is a Guerbet-PO(0-65)-EO(0-100) carboxylate (Guerbet portion can be C6-C36). In some embodiments, the anionic surfactant is alkyl PO(0-65) and EO(0-100) sulfonate: where the alkyl group is linear or branched C6-C36. In some embodiments, the anionic surfactant is a sulfosuccinate, such as a dialkylsulfosuccinate. In some embodiments, the anionic surfactant is an alkyl aryl sulfonate (AAS) (e.g. an alkyl benzene sulfonate (ABS)), a C10-C30 internal olefin sulfate (IOS), a petroleum sulfonate, or an alkyl diphenyl oxide (di)sulfonate.

In some examples, the anionic surfactant can include a branched or unbranched C6-C32:PO(0-65):EO(0-100)-carboxylate, a branched or unbranched C6-C30:PO(30-40):EO(25-35)-carboxylate, a branched or unbranched C6-C12:PO(30-40):EO(25-35)-carboxylate e, a branched or unbranched C6-C30:EO(8-30)-carboxylate, or any combination thereof.

In some examples, the anionic surfactant can include a branched or unbranched C6-C32:PO(0-65):EO(0-100)-sulfate, a branched or unbranched C6-C30:PO(30-40):EO(25-35)-sulfate, a branched or unbranched C6-C12:PO(30-40):EO(25-35)-sulfate, a branched or unbranched C6-C30:EO(8-30)-sulfate, or any combination thereof.

In some examples, the anionic surfactant can include a surfactant defined by the formula below:

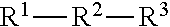

wherein R¹ comprises a branched or unbranched, saturated or unsaturated, cyclic or non-cyclic, hydrophobic carbon chain having 6-32 carbon atoms and an oxygen atom linking R¹ and R²; R² comprises an alkoxylated chain comprising at least one oxide group selected from the group consisting of ethylene oxide, propylene oxide, butylene oxide, and combinations thereof, and R³ comprises a branched or unbranched hydrocarbon chain comprising 1-12 carbon atoms and from 1 to 5 carboxylate groups, from 1-3 sulfate groups, or from 1-3 sulfonate groups.

In some examples, the anionic surfactant can include a surfactant defined by the formula below:

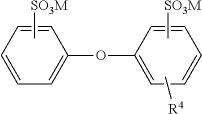

wherein R⁴ is a branched or unbranched, saturated or unsaturated, cyclic or non-cyclic, hydrophobic carbon chain having 6-32 carbon atoms; and M represents a counterion (e.g., Na+, K+). In some embodiments, R⁴ is a branched or unbranched, saturated or unsaturated, cyclic or non-cyclic, hydrophobic carbon chain having 6-16 carbon atoms.

In some embodiments, the non-ionic surfactant and anionic surfactant can be present in the first aqueous formulations and/or the second aqueous formulation in a weight ratio of non-ionic surfactant to anionic surfactant of from 0.5 to 5 (e.g., from 0.5 to 4, from 0.5 to 3, from 0.5 to 2, from 0.5 to 1, from 1 to 5, from 1 to 4, from 1 to 3, from 1 to 2, from 2 to 5, from 2 to 4, from 2 to 3, from 3 to 4, from 3 to 5, or from 4 to 5).

In some embodiments, the surfactant package can include a non-ionic surfactant and an anionic surfactant (e.g., a sulfonate or disulfonate). In some embodiments, surfactant package can include a non-ionic surfactant and two or more anionic surfactants (e.g., a sulfonate or disulfonate and a carboxylate). In some embodiments, the surfactant package can include a non-ionic surfactant (e.g., a C6-C16 alkyl phenol ethoxylate, or a C6-C16:PO(0-25):EO(0-25), such as a C9-C11 ethoxylated alcohol, a C13 ethoxylated alcohol, a C6-C10 ethoxylated propoxylated alcohol, or a C10-C14 ethoxylated Guerbet alcohol) and a sulfonate surfactant (e.g., a C10-16 disulfonate, or a C16-28 IOS). In some embodiments, the surfactant package can include a non-ionic surfactant (e.g., a C6-C16 alkyl phenol ethoxylate, or a C6-16:PO(0-25):EO(0-25), such as a C9-C11 ethoxylated alcohol, a C13 ethoxylated alcohol, a C6-C10 ethoxylated propoxylated alcohol, or a C10-C14 ethoxylated Guerbet alcohol), a sulfonate surfactant (e.g., a C10-16 disulfonate, or a C16-28 IOS), and a carboxylate surfactant (e.g., a C10-16 alkyl polyglucoside carboxylate or a C22-C36 Guerbet alkoxylated carboxylate).

Specific example embodiments include formulations including surfactants and co-surfactants in the table below.

| | Surfactants and Co-Surfactants in formulation |
|---|---|
| Formulation | (in weight percent) |
| 1 | 0.09% alkoxylated C6-C16 alcohol |
| | 0.06% disulfonate |
| 2 | 0.1% alkoxylated C6-C16 alcohol |
| | 0.1% carboxylate |
| | 0.1% disulfonate |
| 3 | 0.15% alkoxylated C6-C16 alcohol |
| | 0.075% carboxylate |
| | 0.075% disulfonate |
| 4 | 0.2% alkoxylated C6-C16 alcohol |
| | 0.1% carboxylate |
| 5 | 0.2% alkoxylated C6-C16 alcohol |
| | 0.033% carboxylate |
| | 0.066% disulfonate |
| 6 | 0.2% alkoxylated C6-C16 alcohol |
| | 0.033% carboxylate |
| | 0.066% disulfonate |
| 7 | 0.2% alkoxylated C6-C16 alcohol |
| | 0.05% carboxylate |
| | 0.05% olefin sulfonate |
| 8 | 0.15% alkoxylated C6-C16 alcohol |
| | 0.05% carboxylate |
| | 0.05% olefin sulfonate |
| | 0.05% alkyl polyglucoside |
| 9 | 0.1% alkoxylated C6-C16 alcohol |
| | 0.05% carboxylate |
| | 0.05% olefin sulfonate |
| | 0.1% alkyl polyglucoside |
| 10 | 0.15% alkoxylated C6-C16 alcohol |
| | 0.07% carboxylate |
| | 0.03% olefin sulfonate |
| | 0.1% alkyl polyglucoside |
| 11 | 0.1% alkoxylated C6-C16 alcohol |
| | 0.04% carboxylate |
| | 0.05% olefin sulfonate |
| | 0.03% disulfonate |
| | 0.1% alkyl polyglucoside |
| 12 | 0.1% alkoxylated C6-C16 alcohol |
| | 0.04% carboxylate |
| | 0.06% disulfonate |
| | 0.1% alkyl polyglucoside |
| 13 | 0.15% alkoxylated C6-C16 alcohol |
| | 0.15% alkoxylated alkylphenol |
| | 0.1% olefin sulfonate |
| | 0.1% Guerbet alkoxylated carboxylate |
| 14 | 0.125% alkoxylated C6-C16 alcohol |
| | 0.175% alkoxylated alkylphenol |
| | 0.1% olefin sulfonate |
| | 0.1% Guerbet alkoxylated carboxylate |
| 15 | 0.1% alkoxylated C6-C16 alcohol |
| | 0.2% alkoxylated alkylphenol |
| | 0.1% olefin sulfonate |
| | 0.1% Guerbet alkoxylated carboxylate |
| 16 | 0.12% alkoxylated C6-C16 alcohol |
| | 0.22% alkoxylated alkylphenol |
| | 0.08% olefin sulfonate |
| | 0.08% Guerbet alkoxylated carboxylate |
| 17 | 0.15% alkoxylated C6-C16 alcohol |
| | 0.15% alkoxylated alkylphenol |
| | 0.08% olefin sulfonate |
| | 0.06% Guerbet alkoxylated carboxylate |
| | 0.06% carboxylate |
| 18 | 0.15% alkoxylated C6-C16 alcohol |
| | 0.15% alkoxylated alkylphenol |
| | 0.05% olefin sulfonate |
| | 0.1% Guerbet alkoxylated carboxylate |
| | 0.05% disulfonate |
| 19 | 0.5% olefin sulfonate |
| | 0.5% Guerbet alkoxylated carboxylate |
| | 0.55% glycosides or glucosides |
| 20 | 0.5% olefin sulfonate |
| | 0.5% Guerbet alkoxylated carboxylate |
| | 0.5% glycosides or glucosides |
| | 0.25% alkoxylated C6-C16 alcohol |
| 21 | 0.5% olefin sulfonate |
| | 0.5% Guerbet alkoxylated carboxylate |
| | 0.5% glycosides or glucosides |
| | 0.5% alkoxylated C6-C16 alcohol |
| 22 | 0.5% olefin sulfonate |
| | 0.5% Guerbet alkoxylated carboxylate |
| | 1% glycosides or glucosides |
| | 0.5% alkoxylated C6-C16 alcohol |
| 23 | 0.05% olefin sulfonate |
| | 0.05% Guerbet alkoxylated carboxylate |
| | 0.05% glycosides or glucosides |
| | 0.05% alkoxylated C6-C16 alcohol |
| 24 | 0.075% glycosides or glucosides |
| | 0.075% alkoxylated C6-C16 alcohol |
| 25 | 0.1% alkoxylated C6-C16 alcohol |
| | 0.05% disulfonate |
| 26 | 0.1% alkoxylated C6-C16 alcohol |
| | 0.05% disulfonate |
| | 0.03% hydroxyalkyl alkylammonium chloride |
| 27 | 0.03% olefin sulfonate |
| | 0.04% Guerbet alkoxylated carboxylate |
| | 0.08% glycosides or glucosides |
| | 0.05% alkoxylated C6-C16 alcohol |
| 28 | 0.4% olefin sulfonate |
| | 0.4% Guerbet alkoxylated carboxylate |
| | 0.7% glycosides or glucosides |
| | 0.5% alkoxylated C6-C16 alcohol |
| 29 | 0.05% olefin sulfonate |
| | 0.1% glycosides or glucosides |
| | 0.05% alkoxylated C6-C16 alcohol |
| 30 | 0.05% olefin sulfonate |
| | 0.1% alkyl polyglucoside |
| | 0.05% alkoxylated C6-C16 alcohol |
| 31 | 0.05% olefin sulfonate |
| | 0.1% glycosides or glucosides |
| | 0.05% alkoxylated C6-C16 alcohol |
| 32 | 0.05% olefin sulfonate |
| | 0.1% alkyl polyglucoside |
| | 0.05% alkoxylated C6-C16 alcohol |
| 33 | 0.05% olefin sulfonate |
| | 0.1% alkyl polyglucoside |
| | 0.05% alkoxylated C6-C16 alcohol |
| 34 | 0.05% olefin sulfonate |
| | 0.05% glycosides or glucosides |
| | 0.05% alkoxylated C6-C16 alcohol |
| | 0.05% carboxylate |
| 35 | 0.05% olefin sulfonate |
| | 0.05% glycosides or glucosides |
| | 0.05% alkoxylated C6-C16 alcohol |
| | 0.05% carboxylate |
| 36 | 0.05% olefin sulfonate |
| | 0.05% alkyl polyglucoside |
| | 0.05% alkoxylated C6-C16 alcohol |
| 37 | 0.06% olefin sulfonate |
| | 0.05% alkyl polyglucoside |
| | 0.04% alkoxylated C6-C16 alcohol |
| 38 | 0.04% olefin sulfonate |
| | 0.08% glycosides or glucosides |
| | 0.05% alkoxylated C6-C16 alcohol |
| | 0.03% disulfonate |
| 39 | 0.035% olefin sulfonate |
| | 0.075% glycosides or glucosides |
| | 0.05% alkoxylated C6-C16 alcohol |
| | 0.04% disulfonate |
| 40 | 0.035% olefin sulfonate |
| | 0.07% glycosides or glucosides |
| | 0.045% alkoxylated C6-C16 alcohol |
| | 0.05% disulfonate |
| 41 | 0.1% alkoxylated C6-C16 alcohol |
| | 0.1% disulfonate |
| 42 | 0.25% Guerbet alkoxylated carboxylate |
| | 0.25% olefin sulfonate |
| | 0.5% glycosides or glucosides |
| | 0.5% co-solvent |
| 43 | 0.075% alkoxylated C12-C22 alcohol |
| | 0.075% disulfonate |
| 44 | 0.075% alkoxylated C6-C16 Guerbet alcohol |
| | 0.075% disulfonate |
| 45 | 0.075% alkoxylated C6-C16 Guerbet alcohol |
| | 0.075% disulfonate |
| 46 | 0.075% alkoxylated C6-C16 alcohol |
| | 0.075% disulfonate |
| 47 | 0.075% disulfonate |
| | 0.075% alkoxylated C6-C16 alcohol |
| 48 | 0.0625% disulfonate |
| | 0.0875% alkoxylated C6-C16 alcohol |
| 49 | 0.055% disulfonate |
| | 0.095% alkoxylated C6-C16 alcohol |
| 50 | 0.075% disulfonate |
| | 0.075% alkoxylated C6-C16 alcohol |
| 51 | 1% alkoxylated C6-C16 alcohol |
| | 0.5% disulfonate |
| 52 | 1% alkoxylated C6-C16 alcohol |
| 53 | 1% alkoxylated C6-C16 alcohol |
| | 2.25% sulfosuccinate |
| 54 | 0.25% Guerbet alkoxylated carboxylate |
| | 1% alkoxylated C6-C16 alcohol |
| | 2.25% sulfosuccinate |
| 55 | 0.25% Guerbet alkoxylated carboxylate |
| | 1% alkoxylated alkylphenol |
| | 2.25% sulfosuccinate |
| 56 | 0.25% Guerbet alkoxylated carboxylate |
| | 1% alkoxylated C6-C16 alcohol |
| 57 | 0.25 Guerbet alkoxylated carboxylate |
| | 1% alkoxylated alkylphenol |
| 58 | 0.65% carboxylate |
| | 0.35% alkoxylated C6-C16 alcohol |
| 59 | 0.325% carboxylate |
| | 0.925% alkoxylated C6-C16 alcohol |
| 60 | 0.25% olefin sulfonate |
| | 1.0% alkoxylated C6-C16 alcohol |
| 61 | 0.15% olefin sulfonate |
| | 0.2% Guerbet alkoxylated carboxylate |
| | 0.92% carboxylate |
| 62 | 0.65% carboxylate |
| | 0.35% second carboxylate |
| 63 | 0.65% carboxylate |
| | 0.35% alkoxylated C6-C16 alcohol |
| | 1% olefin sulfonate |
| 64 | 1% alkoxylated alcohol |
| | 1% olefin sulfonate |
| 65 | 0.5% alkoxylated alcohol |
| | 0.5% olefin sulfonate |
| | 0.25% carboxylate |
| 66 | 0.6% co-solvent |
| | 0.6% olefin sulfonate |
| 67 | 0.6% co-solvent |
| | 0.3% disulfonate |
| | 0.3% olefin sulfonate |
| 68 | 0.6% Guerbet alkoxylated carboxylate |
| | 0.6% disulfonate |
| 69 | 0.6% co-solvent |
| | 0.4% disulfonate |
| | 0.2% olefin sulfonate |
| 70 | 0.5% alkoxylated C6-C16 alcohol |
| | 0.4% disulfonate |
| | 0.3% olefin sulfonate |
| 71 | 1% alkoxylated C6-C16 alcohol |
| 72 | 0.9% alkoxylated C6-C16 alcohol |
| | 0.6% disulfonate |
| 73 | 0.4% alkoxylated C6-C16 alcohol |
| | 0.35% disulfonate |
| | 0.25% olefin sulfonate |
| | 0.5% co-solvent |
| 74 | 0.25% Guerbet alkoxylated carboxylate |
| | 0.5% alkoxylated C6-C16 alcohol |
| | 0.35% disulfonate |
| | 0.15% olefin sulfonate |
| | 0.35% co-solvent |
| 75 | 0.25% Guerbet alkoxylated carboxylate |
| | 0.25% alkoxylated C6-C16 alcohol |
| | 0.25% olefin sulfonate |
| | 0.25% co-solvent |
| 76 | 0.25% Guerbet alkoxylated carboxylate |
| | 0.25% alkoxylated C6-C16 alcohol |
| | 0.25% olefin sulfonate |
| | 0.25% alkoxylated alcohol |
| 77 | 0.25% Guerbet alkoxylated carboxylate |
| | 0.35% olefin sulfonate |
| | 0.5% alkoxylated alcohol |
| 78 | 0.25% Guerbet alkoxylated carboxylate |
| | 0.25% alkoxylated C6-C16 alcohol |
| | 0.15% olefin sulfonate |
| | 0.1% disulfonate |
| | 0.25% co-solvent |
| 79 | 0.25% Guerbet alkoxylated carboxylate |
| | 0.25% alkoxylated C6-C16 alcohol |
| | 0.25% olefin sulfonate |
| | 0.25% glycosides or glucosides |
| | 0.25% co-solvent |
| | 0.15% disulfonate |
| 80 | 0.25% Guerbet alkoxylated carboxylate |
| | 0.25% olefin sulfonate |
| | 0.5% glycosides or glucosides |
| | 0.25% co-solvent |
| 81 | 0.15% alkoxylated C12-C22 alcohol |
| 82 | 0.075% alkoxylated C12-C22 alcohol |
| | 0.075% disulfonate |
| 83 | 0.075% alkoxylated C12-C22 alcohol |
| | 0.075% disulfonate |
| 84 | 0.075% alkoxylated C12-C22 alcohol |
| | 0.075% alkoxylated C6-C16 Guerbet alcohol |
| 85 | 0.15% alkoxylated C6-C16 Guerbet alcohol |
| 86 | 0.075% alkoxylated C6-C16 Guerbet alcohol |
| | 0.075% disulfonate |
| 87 | 0.075% alkoxylated C6-C16 Guerbet alcohol |
| | 0.075% disulfonate |
| | 0.05% co-solvent |
| 88 | 0.1% alkoxylated C6-C16 alcohol |
| | 0.05% disulfonate |
| 89 | 1% alkoxylated C6-C16 alcohol |
| | 0.5% disulfonate |
| 90 | 0.075% alkoxylated C6-C16 Guerbet alcohol |
| | 0.075% disulfonate |
| 91 | 0.075% alkoxylated C6-C16 Guerbet alcohol |
| | 0.125% disulfonate |
| 92 | 0.075% alkoxylated C12-C22 alcohol |
| | 0.125% disulfonate |
| 93 | 0.075% alkoxylated C12-C22 alcohol |
| | 0.075% disulfonate |
| 94 | 0.075% alkoxylated C6-C16 Guerbet alcohol |
| | 0.075% disulfonate |
| 95 | 0.1% alkoxylated C6-C16 Guerbet alcohol |
| | 0.05% disulfonate |
| 96 | 0.075% alkoxylated C6-C16 Guerbet alcohol |
| | 0.075% disulfonate |
| 97 | 0.075% alkoxylated C6-C16 alcohol |
| | 0.075% disulfonate |
| 98 | 0.075% alkoxylated C6-C16 Guerbet alcohol |
| | 0.075% disulfonate |
| 99 | 0.1% alkoxylated C6-C16 alcohol |
| | 0.05% disulfonate |
| 100 | 0.09% alkoxylated C6-C16 alcohol |
| | 0.06% disulfonate |
| 101 | 0.1% alkoxylated C6-C16 alcohol |
| | 0.1% disulfonate |
| | 0.1% Guerbet alkoxylated carboxylate |
| 102 | 0.1% alkoxylated C6-C16 alcohol |
| | 0.1% disulfonate |
| 103 | 0.65% Guerbet alkoxylated carboxylate |
| | 0.35% olefin sulfonate |
| | 0.33% alkoxylated alkylphenol |
| | 0.5% co-solvent |
| | 0.25% second co-solvent |
| 104 | 0.075% alkoxylated C6-C16 alcohol |
| | 0.075% benzenesulfonic acid, decyl(sulfophenoxy)- |
| | disodium salt |
| 105 | 0.15% alkoxylated C6-C16 alcohol |
| | 0.05% benzenesulfonic acid, decyl(sulfophenoxy)- |
| | disodium salt |

In some embodiments, the miscible solvent can be present in the first aqueous formulation in a concentration of can of at least 0.10% by weight (e.g., at least 0.50% by weight, at least 1% by weight, at least 2.5% by weight, at least 5% by weight, at least 7.5% by weight, at least 10% by weight, at least 12.5% by weight, or at least 15% by weight), based on the total weight of the first aqueous formulation.

In some embodiments, the first aqueous formulation including the miscible solvent can include 20% by weight or less (e.g., 15% by weight or less, 12.5% by weight or less, 10% by weight or less, 7.5% by weight or less, 5% by weight or less, 2.5% by weight or less, 1% by weight or less, or 0.5% by weight or less), based on the total weight of the first aqueous formulation.

The amount of miscible solvent present in the first aqueous formulation including miscible solvent can range from any of the minimum values described above to any of the maximum values described above. For example, in some embodiment, the amount of the miscible solvent present in the first aqueous formulation including the miscible solvent can include from 0.10% to 20% by weight (e.g., from 0.1% to 5% by weight, from 0.1% to 10% by weight, from 0.1% to 15% by weight, from 0.1% to 20% by weight, from 1% to 5% by weight, from 1% to 10% by weight, from 1% to 15% by weight, from 1% to 20% by weight from 2.5% to 10% by weight, from 2.5% to 15% by weight, from 2.5% to 20% by weight, from 5% to 10% by weight, from 5% to 15% by weight, from 5% to 20% by weight, from 7.5% to 10% by weight, from 7.5% to 15% by weight, 7.5% to 20% by weight, from 10% to 15% by weight, from 10% to 20% by weight, or from 15% to 20% by weight), based on the total weight of the first aqueous formulation.

In some embodiments, the miscible solvent and surfactant package are present in the first aqueous formulation in a ratio of at least 1:0.0005 (e.g., at least 1:0.001, at least 1:0.01, at least 1:0.1, at least 1:1, at least 1:10, at least 1:25, at least 1:50, or at least 1:100).

In some embodiments, the miscible solvent and surfactant package are present in the first aqueous formulation in a ratio of 1:200 or less (e.g., 1:100 or less, 1:50 or less, 1:25 or less, 1:10, less or 1:1 or less, 1:0.1 or less, 1:0.01 or less, or 1:0.01 or less).

The miscible solvent and surfactant package are present in the first aqueous formulation in a ratio ranging from any of the minimum values described above. For example, in some embodiments, the miscible solvent and the surfactant package can be present in the first aqueous formulation in the first aqueous formulation in a ratio of from 1:0.0005 to 1:200 (e.g., from 1:0.0005 to 1:100, from 1:0.0005 to 1:50, from 1:0.0005 to 1:25, from 1:0.0005 to 1:10, from 1:0.0005 to 1:5, from 1:0.001 to 1:200, from 1:0.001 to 1:100, from 1:0.001 to 1:50, from 1:0.001 to 1:25, from 1:0.001 to 1:10, from 1:0.001 to 1:5, from 1:0.001 to 1:1, from 1:0.01 to 1:200, from 1:0.01 to 1:100, from 1:0.01 to 1:50, from 1:0.01 to 1:25, from 1:0.01 to 1:10, from 1:0.01 to 1:5, from 1:0.01 to 1:1, from 1:0.1 to 1:200, from 1:0.1 to 1:100, from 1:0.1 to 1:50, from 1:0.1 to 1:25, from 1:0.1 to 1:10, from 1:0.1 to 1:5, from 1:0.1 to 1:1, from 1:1 to 1:200, from 1:1 to 1:100, from 1:1 to 1:50, from 1:1 to 1:25, from 1:1 to 1:10, from 1:1 to 1:5, from 1:5 to 1:200, from 1:5 to 1:100, from 1:5 to 1:50, from 1:5 to 1:25, from 1: to 1:10, from 1:10 to 1:200, from 1:10 to 1:100, from 1:10 to 1:50, from 1:10 to 1:25, from 1:25 to 1:200, from 1:25 to 1:100, from 1:25 to 1:50, from 1:50 to 1:200, from 1:50 to 1:100, or from 1:100 to 1:200). in some embodiments, the miscible solvent and the surfactant package can be present in the first aqueous formulation in the first aqueous formulation in a ratio of 1:10 or 1:1.

In some embodiments, when present the miscible solvent can be present in the second aqueous formulation in a concentration of at least 0.001% by weight (e.g., at least 0.005% by weight, at least 0.01% by weight, at least 0.05% by weight, at least 0.08% by weight, at least 0.1% by weight, at least 0.5% by weight, at least 1% by weight, or at least 2.5% by weight), based on the total weight of the second aqueous formulation.

In some embodiments, when present the miscible solvent can be present in the second aqueous formulation in a concentration of 5% by weight or less (e.g., 2.5% by weight or less, 1% by weight or less, 0.5% by weight or less, 0.1% by weight or less, 0.08% by weight or less, 0.05% by weight or less, 0.01% by weight or less, or 0.005% by weight or less), based on the total weight of the second aqueous formulation.

The miscible solvent can be present in the second aqueous formulation in a concentration ranging from any of the minimum values described above to any of the maximum values described above. For example, in some embodiment, the miscible solvent can be present in the second aqueous formulation in a concentration of from 0% to 5% by weight (e.g., from 0% to 2.5% by weight, from 0% to 1% by weight, from 0% to 0.5% by weight, from 0% to 0.1% by weight, from 0.001% to 2.5% by weight, from 0.001% to 1% by weight, from 0.001% to 0.5% by weight, from 0.01% to 2.5% by weight, from 0.01% to 1% by weight, from 0.01% to 0.5% by weight, from 0.1% to 2.5% by weight, from 0.1% to 1% by weight, from 0.1% to 0.5% by weight, from 1% to 2.5% by weight, from 0.001% to 0.1% by weight, from 0.001% to 0.05% by weight, from 0.001% to 0.01% by weight, from 0.001% to 0.005% by weight, from 0.01% to 0.05% by weight, from 0.01% to 0.1% by weight, or from 0.05% to 0.1% by weight), based on the total weight of the second aqueous formulation.

In some embodiments, the miscible solvent and surfactant package are present in the second aqueous formulation in a ratio of at least 1:0.0005 (e.g., at least 1:1, at least 1:0.1, at least 1:100, or at least 1:200).

In some embodiments, the miscible solvent and surfactant package are present in the second aqueous formulation in a ratio of 1:200,000 or less (e.g., 1:200 or less, 1:100 or less, 1:0.1 or less, or 1:1 or less).

The miscible solvent and surfactant package can be present in the second aqueous formulation in a ratio ranging from any of the minimum values described above. For example, in some embodiments, the miscible solvent and the surfactant package can be present in the second aqueous formulation in the second aqueous formulation in a ratio of from 1:0.0005 to 1:200,000 (e.g., from 1:0.001 to 1:100,000, from 1:0.001 to 1:50,000, from 1:0.001 to 1:10,000, from 1:0.001 to 1:5,000, from 1:0.001 to 1:1,000, from 1:0.001 to 1:500, from 1:0.001 to 1:100, from 1:0.001 to 1:50, from 1:0.001 to 1:10, from 1:0.001 to 1:5, from 1:0.001 to 1:1, from 1:0.01 to 1:200,000, from 1:0.01 to 1:100,000, from 1:0.01 to 1:50,000, from 1:0.01 to 1:10,000, from 1:0.01 to 1:5,000, from 1:0.01 to 1:1,000, from 1:0.01 to 1:500, from 1:0.01 to 1:100, from 1:0.01 to 1:50, from 1:0.01 to 1:10, from 1:0.01 to 1:5, from 1:0.01 to 1:1, from 1:0.1 to 1:200,000, from 1:0.1 to 1:100,000, from 1:0.1 to 1:50,000, from 1:0.1 to 1:10,000, from 1:0.1 to 1:5,000, from 1:0.1 to 1:1,000, from 1:0.1 to 1:500, from 1:0.1 to 1:100, from 1:0.1 to 1:50, from 1:0.1 to 1:10, from 1:0.1 to 1:5, from 1:0.1 to 1:1, from 1:1 to 1:200,000, from 1:1 to 1:100,000, from 1:1 to 1:50,000, from 1:1 to 1:10,000, from 1:1 to 1:5,000, from 1:1 to 1:1,000, from 1:1 to 1:500, from 1:1 to 1:100, from 1:1 to 1:50, from 1:1 to 1:10, from 1:1 to 1:5, from, from 1:5 to 1:200,000, from 1:5 to 1:100,000, from 1:5 to 1:50,000, from 1:5 to 1:10,000, from 1:5 to 1:5,000, from 1:5 to 1:1,000, from 1:5 to 1:500, from 1:5 to 1:100, from 1:5 to 1:50, from 1:5 to 1:10, from 1:10 to 1:200,000, from 1:10 to 1:100,000, from 1:10 to 1:50,000, from 1:10 to 1:10,000, from 1:10 to 1:5,000, from 1:10 to 1:1,000, from 1:10 to 1:500, from 1:10 to 1:100, from 1:10 to 1:50, from 1:50 to 1:200,000, from 1:50 to 1:100,000, from 1:50 to 1:50,000, from 1:50 to 1:10,000, from 1:50 to 1:5,000, from 1:50 to 1:1,000, from 1:50 to 1:500, from 1:50 to 1:100, from 1:100 to 1:200,000, from 1:100 to 1:100,000, from 1:100 to 1:50,000, from 1:100 to 1:10,000, from 1:100 to 1:5,000, from 1:100 to 1:1,000, from 1:100 to 1:500, from 1:500 to 1:200,000, from 1:500 to 1:100,000, from 1:500 to 1:50,000, from 1:500 to 1:10,000, from 1:500 to 1:5,000, from 1:500 to 1:1,000, from 1:1,000 to 1:200,000, from 1:1,000 to 1:100,000, from 1:1,000 to 1:50,000, from 1:1,000 to 1:10,000, from 1:1,000 to 1:5,000, from 1:5,000 to 1:200,000, from 1:5,000 to 1:100,000, from 1:5,000 to 1:50,000, from 1:5,000 to 1:10,000, from 1:10,000 to 1:200,000, from 1:10,000 to 1:100,000, from 1:10,000 to 1:50,000, from 1:50,000 to 1:200,000, from 1:50,000 to 1:100,000, or from 1:100,000 to 1:200,000). In some embodiments, the miscible solvent and the surfactant package can be present in the second aqueous formulation in the second aqueous formulation in a ratio of 1:0.1, 1:10, 1:100, 1:200, or 1:1).

In some embodiments, the miscible solvent can exhibit a partition coefficient of at least 0.01 (e.g., at least 0.05, at least 0.1, at least 0.2, at least 0.25, at least 0.3, at least 0.4, at least 0.5, at least 0.6, at least 0.7, at least 0.75, at least 0.8, at least 0.9, at least 1.0, at least 1.05, at least 1.1, at least 1.15, at least 1.2, at least 1.25, at least 1.5, at least 2, or at least 2.5) with the hydrocarbons present in the subterranean formation. In some embodiments, the miscible solvent can exhibit a partition coefficient of 3 or less (e.g., 2.5 or less, 2 or less, 1.5 or less, 1.25 or less, 1.2 or less, 1.15 or less, 1.1 or less, 1.05 or less, 1.0 or less, 0.9 or less, 0.8 or less, 0.75 or less, 0.7 or less, 0.6 or less, 0.5 or less, 0.4 or less, 0.3 or less, 0.25 or less, 0.2 or less, 0.1 or less, or 0.05 or less) with the hydrocarbons present in the subterranean formation.

The miscible solvent can exhibit a partition coefficient ranging from any of the minimum values described above. For example, in some embodiments, the miscible solvent can exhibit a partition coefficient of from 0.01 to 3 (e.g., from 0.01 to 2.5, from 0.01 to 2, from 0.01 to 1.5, from 0.01 to 1.0, from 0.01 to 0.5, from 0.01 to 0.25, from 0.01 to 0.1, from 0.01 to 0.05, from 0.05 to 3, from 0.05 to 2.5, from 0.05 to 2, from 0.05 to 1.5, from 0.05 to 1.0, from 0.05 to 0.5, from 0.05 to 0.25, from 0.05 to 0.1, from 0.1 to 3, from 0.1 to 2.5, from 0.1 to 2, from 0.1 to 1.5, from 0.1 to 1.0, from 0.1 to 0.5, from 0.5 to 3, from 0.5 to 2.5, from 0.5 to 2, from 0.5 to 1.5, from 0.5 to 1.0, from 1 to 3, from 1 to 2.5, from 1 to 2, from 1 to 1.5, from 1.5 to 3, from 1.5 to 2.5, from 1.5 to 2, from 2 to 2.5, or from 2 to 3) with the hydrocarbons present in the subterranean formation.

In some embodiments, the miscible solvent can include dimethyl ether (DME). In some embodiment, the miscible solvent can further include a sacrificial co-solvent. Suitable sacrificial co-solvents can include, but are not limited to, ethylene glycol monobutyl ether (EGBE), diethylene glycol monobutyl ether (DEGBE), triethylene glycol monobutyl ether (TEGBE), C₄-C₉ alcohol (e.g., 4-methyl-2-pentanol (also known as methylisobutyl carbinol), hexanol (e.g., n-hexanol), 2-ethylhexanol (e.g., 2-ethyl-1-hexanol), 2-butoxyethanol, benzyl alcohol, isopropyl alcohol (IPA), isobutyl alcohol (IBA), sec-butanol, tert-butanol, pentaerythritol, trimethylolpropane), 4-methyl-2-pentanol-1PO-5EO, isobutyl alcohol-1PO-2EO, phenol-2PO-2EO, phenol-1PO-5EO, or any combination thereof. In some embodiments, the miscible solvent can be dimethyl ether (DME), C₄-C₉ alcohol (e.g., 4-methyl-2-pentanol (also known as methylisobutyl carbinol), hexanol (e.g., n-hexanol), 2-ethylhexanol (e.g., 2-ethyl-1-hexanol), 2-butoxyethanol, benzyl alcohol, sec-butanol, tert-butanol, pentaerythritol, trimethylolpropane), or any combination thereof.

In some embodiments, In some embodiments, the miscible solvent can include dimethyl ether (DME), and optionally a sacrificial co-solvents selected from ethylene glycol monobutyl ether (EGBE), diethylene glycol monobutyl ether (DEGBE), triethylene glycol monobutyl ether (TEGBE), C₄-C₉ alcohol (e.g., 4-methyl-2-pentanol (also known as methylisobutyl carbinol), hexanol (e.g., n-hexanol), 2-ethylhexanol (e.g., 2-ethyl-1-hexanol), 2-butoxyethanol, benzyl alcohol, isopropyl alcohol (IPA), isobutyl alcohol (IBA), sec-butanol, tert-butanol, pentaerythritol, trimethylolpropane), 4-methyl-2-pentanol-1PO-5EO, isobutyl alcohol-1PO-2EO, phenol-2PO-2EO, phenol-1PO-5EO, or any combination thereof. In some embodiments, the miscible solvent can be dimethyl ether (DME), C₄-C₉ alcohol (e.g., 4-methyl-2-pentanol (also known as methylisobutyl carbinol), hexanol (e.g., n-hexanol), 2-ethylhexanol (e.g., 2-ethyl-1-hexanol), 2-butoxyethanol, benzyl alcohol, sec-butanol, tert-butanol, pentaerythritol, trimethylolpropane), or any combination thereof.

In some embodiments, the miscible solvent can be dimethyl ether (DME). In some embodiments, the miscible solvent can be neat dimethyl ether.

Optionally, the first aqueous formulations and/or the second aqueous formulation can include one or more additional components. For example, the first aqueous formulations and/or the second aqueous formulation can further include water, an acid, an alkali agent, co-solvent, a co-surfactant, a foam stabilizer, a breaker, a friction reducer, a pH adjusting agent, an iron control agent, a corrosion inhibitor, a scale inhibitor, a biocide, a clay stabilizing agent, or any combination thereof or any combination thereof.

In some embodiments, the first aqueous formulation and/or the second aqueous formulation can further include an aqueous polymer. Suitable aqueous polymers can include, but are not limited to, a synthetic polymer, a naturally occurring polymer (a biopolymer), self-destructing polymer, or any combination thereof.

In some examples, the aqueous polymer can include a synthetic polymer. Examples of suitable synthetic polymers include polyacrylamides, such as partially hydrolyzed polyacrylamides (HPAMs or PHPAs), and hydrophobically-modified associative polymers (APs). Other examples include co-polymers of polyacrylamide (PAM) and one or both of 2-acrylamido 2-methylpropane sulfonic acid (and/or sodium salt) commonly referred to as AMPS (also more generally known as acrylamido tertiobutyl sulfonic acid or ATBS), N-vinyl pyrrolidone (NVP), and the NVP-based synthetic may be single-, co-, or ter-polymers. In one embodiment, the synthetic polymer is polyacrylic acid (PAA). In one embodiment, the synthetic polymer is polyvinyl alcohol (PVA). Copolymers may be made of any combination or mixture above, for example, a combination of NVP and ATBS.

In some examples, the aqueous polymer can include a synthetic polymer, such as hydrolyzed polyacrylamide (HPAM), N-vinylpyrrolidone (NVP), acrylamide tertiary butyl sulfonic acid (ATBS), 2-acrylamido-2-methylpropane sulfonic acid (AMPS), or any combination thereof. In some examples, the first aqueous formulation and/or the second aqueous formulation aqueous polymer solution can include a blend of a biopolymer and a synthetic polymer.

In some examples, the aqueous polymer can include a biopolymer, such as a triple-helix forming biopolymer. In some examples, the aqueous polymer solution includes a polysaccharide. In some examples, the aqueous polymer solution can be selected from xanthan, guar, a scleroglucan, a schizophyllan, hydroxyethyl cellulose (HEC), or any combination thereof.

In some examples, the aqueous polymer can include a self-destructing polymer.

Self-destructing polymers refer to polymers that autonomously degrade upon specific triggers such as heat, chemicals, light, enzymes, moisture, or any combination thereof.

In some embodiments, the aqueous polymer can be present in the first aqueous formulation and/or the second aqueous formulation in an amount of at least 500 ppm (e.g., at least 1,000 ppm, at least 2,000 ppm, at least 3,000 ppm, at least 4,000 ppm, at least 5,000 ppm, at least 6,000 ppm, at least 7,000 ppm, at least 8,000 ppm, or at least 9,000 ppm).

In some embodiments, the aqueous polymer can be present in the first aqueous formulation and/or the second aqueous formulation in an amount of 10,000 ppm or less (e.g., 9,000 ppm or less, 8,000 ppm or less, 7,000 ppm or less, 6,000 ppm or less, 5,000 ppm or less, 4,000 ppm or less, 3,000 ppm or less, 2,000 ppm or less, or 1,000 ppm or less).

The aqueous polymer can be present in the first aqueous formulation and/or the second aqueous formulation in a concentration ranging from any of the minimum values described above to any of the maximum values described above. For example, in some embodiments, the aqueous polymer can be present in the first aqueous formulation and/or the second aqueous formulation in an amount of from 500 to 10,000 ppm (e.g. from 500 to 1,000 ppm, from 500 to 2,000 ppm, from 500 to 3,000 ppm, from 500 to 4,000 ppm, from 500 to 5,000 ppm, from 500 to 6,000 ppm, from 500 to 7,000 ppm, from 500 to 8,000 ppm, from 500 to 9,000 ppm, from 1,000 to 2,000 ppm, from 1,000 to 3,000 ppm, from 1,000 to 4,000 ppm, from 1,000 to 5,000 ppm, from 1,000 to 6,000 ppm, from 1,000 to 7,000 ppm, from 1,000 to 8,000 ppm, from 1,000 ppm to 9,000 ppm, from 1,000 ppm to 10,000 ppm, from 2,000 ppm to 3,000 ppm, from 2,000 ppm to 4,000 ppm, from 2,000 ppm to 5,000 ppm, from 2,000 ppm to 6,000 ppm, from 2,000 ppm to 7,000 ppm, from 2,000 ppm to 8,000 ppm, from 2,000 ppm to 9,000 ppm, from 2,000 ppm to 10,000 ppm, from 3,000 ppm to 4,000 ppm, from 3,000 ppm to 5,000 ppm, from 3,000 ppm to 6,000 ppm, from 3,000 ppm to 7,000 ppm, from 3,000 ppm to 8,000 ppm, from 3,000 ppm to 9,000 ppm, from 3,000 ppm to 10,000 ppm, from 4,000 ppm to 5,000 ppm, from 4,000 ppm to 6,000 ppm, from 4,000 ppm to 7,000 ppm, from 4,000 ppm to 8,000 ppm, from 4,000 ppm to 9,000 ppm, from 4,000 ppm to 10,000 ppm, from 5,000 ppm to 6,000 ppm, from 5,000 ppm to 7,000 ppm, from 5,000 ppm to 6,000 ppm, from 5,000 ppm to 7,000 ppm, from 5,000 ppm to 8,000 ppm, from 5,000 ppm to 9,000 ppm, from 5,000 ppm to 10,000 ppm, from 6,000 ppm to 7,000 ppm, from 6,000 ppm to 8,000 ppm, from 6,000 ppm to 9,000 ppm, from 6,000 ppm to 10,000 ppm, from 7,000 ppm to 8,000 ppm, from 7,000 ppm to 9,000 ppm, from 7,000 ppm to 10,000 ppm, from 8,000 ppm to 9,000 ppm, from 8,000 ppm to 10,000 ppm, or from 9,000 ppm to 10,000 ppm). In some embodiments, the aqueous polymer can be present in the first aqueous formulation and/or the second aqueous formulation in an amount of from 2,500 ppm to 7,500 ppm or from 4,000 ppm to 6,000 ppm.

In some embodiments, the first aqueous formulation and/or the second aqueous formulation can further include one or more co-solvents. Suitable co-solvents include alcohols, such as lower carbon chain alcohols such as isopropyl alcohol, ethanol, n-propyl alcohol, n-butyl alcohol, sec-butyl alcohol, n-amyl alcohol, sec-amyl alcohol, n-hexyl alcohol, sec-hexyl alcohol and the like; alcohol ethers, polyalkylene alcohol ethers, polyalkylene glycols, poly(oxyalkylene)glycols, poly(oxyalkylene)glycol ethers, ethoxylated phenol, or any other common organic co-solvent or combinations of any two or more co-solvents. In one embodiment, the co-solvent can include alkyl ethoxylate (C1-C6)-XEO X=1-30—linear or branched. In some embodiments, the co-solvent can include ethylene glycol butyl ether (EGBE), diethylene glycol monobutyl ether (DGBE), triethylene glycol monobutyl ether (TEGBE), ethylene glycol dibutyl ether (EGDE), polyethylene glycol monomethyl ether (mPEG), or any combination thereof. In some embodiments, the first aqueous formulations and/or the second aqueous formulation can further include a co-solvent (e.g., a C₁-C₅ alcohol, or an alkoxylated C1-C5 alcohol), or any combination thereof).

In some embodiments, the co-solvent can have a concentration within the first aqueous formulations and/or the second aqueous formulation of at least 0.5% by weight (e.g., at least 1%, at least 5%, at least 10%, at least 20%, at least 30%, at least 40%, or at least 50%).

In some embodiments, the co-solvent can have a concentration within the aqueous formulation of 60% or less by weight (e.g., 50% or less, 40% or less, 30% or less, 20% or less, 10% or less, 5% or less, or 1% or less).

The co-solvent can have a concentration within the first aqueous formulation and/or the second aqueous formulation can range from any of the minimum values described above to any of the maximum values described above. For example, in some embodiments, the co-solvent can have a concentration within the first aqueous formulation and/or the second aqueous formulation of from 0.5% to 60% by weight (e.g., from 0.5% to 50%, from 0.5% to 40%, from 0.5% to 30%, from 0.5% to 20%, from 0.5% to 10%, from 0.5% to 5%, from 0.5% to 1%, from 1% to 50%, from 1% to 40%, from 1% to 30%, from 1% to 20%, from 1% to 10%, from 1% to 5%, from 5% to 50%, from 5% to 40%, from 5% to 30%, from 5% to 20%, from 5% to 10%, from 10% to 50%, from 10% to 40%, from 10% to 30%, from 10% to 20%, from 20% to 50%, from 20% to 40%, from 20% to 30%, from 30% to 50%, from 30% to 40%, or from 40% to 50%).

In some embodiments, the first aqueous formulation and/or the second aqueous formulation can further include water. The water used to form the first aqueous formulation and/or the second aqueous formulation can include any type of water, treated or untreated, and can vary in salt content. For example, the water can include sea water, brackish water, flowback or produced water, wastewater (e.g., reclaimed or recycled), brine (e.g., reservoir or synthetic brine), fresh water (e.g., fresh water comprises <1,000 ppm TDS water), or any combination thereof. In certain examples, the water can include hard water or hard brine. In some embodiments, the water can include at least 10 ppm of divalent metal ions (e.g., at least 100 ppm, at least 500 ppm, at least 1,000 ppm, at least 5,000 ppm, at least 10,000 ppm, at least 20,000 ppm, or at least 30,000 ppm). In some embodiments, the water can include 30,000 ppm or less of divalent metal ions (e.g., 20,000 ppm or less, 10,000 ppm or less, 5,000 ppm or less, 1,000 ppm or less, 500 ppm or less, 100 ppm or less, or 50 ppm or less). In certain embodiments, the from 10 ppm to 30,000 ppm of divalent metal ions.

The water can have a concentration of divalent metal ions ranging from any of the minimum values described above to any of the maximum values described above. For example, in some embodiments, the water can include from 10 ppm to 30,000 ppm of divalent metal ions (e.g., from 50 ppm to 30,000 ppm, from 100 ppm to 30,000 ppm, from 500 ppm to 30,000 ppm, from 1000 ppm to 30,000 ppm, from 5000 ppm to 30,000 ppm, from 10,000 ppm to 30,000 ppm, from 20,000 ppm to 30,000 ppm, from 10 ppm to 20,000 ppm, from 50 ppm to 20,000 ppm, from 100 ppm to 20,000 ppm, from 500 ppm to 20,000 ppm, from 1000 ppm to 20,000 ppm, from 5000 ppm to 20,000 ppm, from 10,000 ppm to 20,000 ppm, from 10 ppm to 10,000 ppm, from 50 ppm to 10,000 ppm, from 100 ppm to 10,000 ppm, from 500 ppm to 10,000 ppm, from 1000 ppm to 10,000 ppm, from 5000 ppm to 10,000 ppm, from 10 ppm to 5,000 ppm, from 50 ppm to 5,000 ppm, from 100 ppm to 5,000 ppm, from 500 ppm to 5,000 ppm, from 1000 ppm to 5,000 ppm, from 10 ppm to 1,000 ppm, from 50 ppm to 1,000 ppm, from 100 ppm to 20,000 ppm, from 500 ppm to 1,000 ppm, from 10 ppm to 500 ppm, from 50 ppm to 500 ppm, from 100 ppm to 500 ppm, from 10 ppm to 100 ppm, from 50 ppm to 100 ppm, or from 10 ppm to 50 ppm). In some embodiments, the divalent metal ions can be chosen from Ca²⁺, Mg²⁺, Sr²⁺, and Ba²⁺, or any combination thereof.

In some embodiments, the water can have salinity of at least 5,000 ppm TDS (e.g., at least 10,000 ppm TDS, at least 20,000 ppm TDS, at least 30,000 ppm TDS, at least 50,000 ppm TDS, at least 75,0000 ppm TDS, at least 100,000 ppm TDS, at least 150,000 ppm TDS, at least 200,000 ppm TDS, at least 250,000 ppm TDS, or at least 275,000 ppm TDS). In some embodiments, the water can have a salinity of 300,000 ppm TDS or less (e.g., 275,000 ppm TDS or less, 250,000 ppm TDS or less, 200,000 ppm TDS or less, 150,000 ppm TDS or less, 100,000 ppm TDS or less, 50,000 ppm TDS or less, 30,000 ppm TDS or less, 25,000 ppm TDS or less, 20,000 ppm TDS or less, 15,000 ppm TDS or less, or 10,000 ppm TDS or less).

The water can have a salinity ranging from any of the minimum values described above to any of the maximum values described above. For example, in some embodiments, the water can have a salinity of at least 5,000 ppm TDS to 300,000 ppm TDS, such as a salinity of from 5,000 ppm TDS to 10,000 ppm TDS, from 5,000 ppm TDS to 15,000 ppm TDS, from 5,000 ppm TDS to 30,000 ppm TDS, from 5,000 ppm TDS to 50,000 ppm TDS, from 5,000 ppm TDS to 100,000 ppm TDS, from 5,000 ppm TDS to 150,000 ppm TDS, from 5,000 ppm TDS to 200,000 ppm TDS, from 5,000 ppm TDS to 250,000 ppm TDS, from 5,000 ppm TDS to 300,000 ppm TDS, from 15,000 ppm TDS to 30,000 ppm TDS, from 15,000 ppm TDS to 50,000 ppm TDS, from 15,000 ppm TDS to 100,000 ppm TDS, from 15,000 ppm TDS to 150,000 ppm TDS, from 15,000 ppm TDS to 200,000 ppm TDS, from 15,000 ppm TDS to 250,000 ppm TDS, from 15,000 ppm TDS to 300,000 ppm TDS, from 20,000 ppm TDS to 50,000 ppm TDS, from 20,000 ppm TDS to 100,000 ppm TDS, from 20,000 ppm TDS to 150,000 ppm TDS, from 20,000 ppm TDS to 200,000 ppm TDS, from 20,000 ppm TDS to 250,000 ppm TDS, from 20,000 ppm TDS to 300,000 ppm TDS, from 25,000 ppm TDS to 50,000 ppm TDS, from 25,000 ppm TDS to 100,000 ppm TDS, from 25,000 ppm TDS to 150,000 ppm TDS, from 25,000 ppm TDS to 200,000 ppm TDS, from 25,000 ppm TDS to 250,000 ppm TDS, from 25,000 ppm TDS to 300,000 ppm TDS, from 50,000 ppm TDS to 100,000 ppm TDS, from 50,000 ppm TDS to 150,000 ppm TDS, from 50,000 ppm TDS to 200,000 ppm TDS, from 50,000 ppm TDS to 250,000 ppm TDS, from 50,000 ppm TDS to 300,000 ppm TDS, from 100,000 ppm TDS to 150,000 ppm TDS, from 100,000 ppm TDS to 200,000 ppm TDS, from 100,000 ppm TDS to 250,000 ppm TDS, from 100,000 ppm TDS to 300,000 ppm TDS, from 150,000 ppm TDS to 200,000 ppm TDS, from 150,000 ppm TDS to 250,000 ppm TDS, from 150,000 ppm TDS to 300,000 ppm TDS, from 200,000 ppm TDS to 250,000 ppm TDS, from 200,000 ppm TDS to 300,000 ppm TDS, or from 250,000 ppm TDS to 300,000 ppm TDS.

In some embodiments, oil recovery using the first aqueous formulation described herein can be tested using a core flood experiment. A core flood experiment can be performed using a surrogate rock for the subterranean formation. The term “surrogate rock” as used herein, refers to a sample rock that has the same porosity or lower porosity as the target subterranean formation. In certain embodiments, the surrogate rock can have the same surface chemistry as the target subterranean formation. In some embodiments, the core including the surrogate rock for the subterranean formation is a Bentheimer sandstone core.

In some embodiments, when the first aqueous formulation is injected into a core including a surrogate rock for the subterranean formation, a total hydrocarbon recovery of at least a 95% can be achieved (e.g., from 95% to 100%, from 96% to 100%, from 97% to 100%, from 98% to 100%, from 99% to 100%, from 95% to 99%, from 96% to 99%, from 97% to 99%, from 98% to 99%, from 95% to 98%, from 96% to 98%, from 97% to 98%, from 95% to 97%, from 96% to 97%, from 97% to 98%, from 98% to 98%, or from 98% to 99%). In some embodiments, when the first aqueous formulation is injected into a core including a surrogate rock for the subterranean formation at an interstitial velocity of 1 ft/day and at a temperature of 44° C., a total hydrocarbon recovery of at least a 95% can be achieved (e.g., from 95% to 100%, from 96% to 100%, from 97% to 100%, from 98% to 100%, from 99% to 100%, from 95% to 99%, from 96% to 99%, from 97% to 99%, from 98% to 99%, from 95% to 98%, from 96% to 98%, from 97% to 98%, from 95% to 97%, from 96% to 97%, from 97% to 98%, from 98% to 98%, or from 98% to 99%). In some embodiments, when 0.3 pore volumes of the first aqueous formulation are injected into a core including a surrogate rock for the subterranean formation, a total hydrocarbon recovery of at least a 95% can be achieved (e.g., from 95% to 100%, from 96% to 100%, from 97% to 100%, from 98% to 100%, from 99% to 100%, from 95% to 99%, from 96% to 99%, from 97% to 99%, from 98% to 99%, from 95% to 98%, from 96% to 98%, from 97% to 98%, from 95% to 97%, from 96% to 97%, from 97% to 98%, from 98% to 98%, or from 98% to 99%).

In some embodiments, when the first aqueous formulation is injected into a Bentheimer sandstone core a total hydrocarbon recovery of at least a 95% can be achieved (e.g., from 95% to 100%, from 96% to 100%, from 97% to 100%, from 98% to 100%, from 99% to 100%, from 95% to 99%, from 96% to 99%, from 97% to 99%, from 98% to 99%, from 95% to 98%, from 96% to 98%, from 97% to 98%, from 95% to 97%, from 96% to 97%, from 97% to 98%, from 98% to 98%, or from 98% to 99%). In some embodiments, when the first aqueous formulation is injected into a Bentheimer sandstone core at an interstitial velocity of 1 ft/day and at a temperature of 44° C., a total hydrocarbon recovery of at least a 95% can be achieved (e.g., from 95% to 100%, from 96% to 100%, from 97% to 100%, from 98% to 100%, from 99% to 100%, from 95% to 99%, from 96% to 99%, from 97% to 99%, from 98% to 99%, from 95% to 98%, from 96% to 98%, from 97% to 98%, from 95% to 97%, from 96% to 97%, from 97% to 98%, from 98% to 98%, or from 98% to 99%). In some embodiments, when 0.3 pore volumes of the first aqueous formulation is injected into a Bentheimer sandstone core, a total hydrocarbon recovery of at least a 95% can be achieved (e.g., from 95% to 100%, from 96% to 100%, from 97% to 100%, from 98% to 100%, from 99% to 100%, from 95% to 99%, from 96% to 99%, from 97% to 99%, from 98% to 99%, from 95% to 98%, from 96% to 98%, from 97% to 98%, from 95% to 97%, from 96% to 97%, from 97% to 98%, from 98% to 98%, or from 98% to 99%).

The compositions and methods described herein can also relate to aspects of the methods and compositions described in U.S. Patent Application Publication Nos. 2025-0289994 and 2025/0290397, and U.S. Provisional Patent Application Nos. 63/884,306, 63/884,301, 63/925,391, each of which is hereby incorporated herein by reference in its entirety.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are both chemically related may be substituted for the agents described herein while the same or similar results would be achieved. All such similar substitutes and modifications apparent to those skilled in the art are deemed to be within the spirit, scope and concept of the disclosure as defined by the appended claims.

By way of non-limiting illustration, examples of certain embodiments of the present disclosure are given below.

### EXAMPLES

### Example 1: Conventional Chemical EOR Application Without Salinity or Chemical Gradient

Enhanced Oil Recovery (EOR) techniques are employed to maximize the extraction of oil from reservoirs after primary and secondary recovery methods have been exhausted. Among the various EOR methods, chemical EOR has proven to be an effective technique. Successful surfactant flooding generally requires the use of salinity gradients. The purpose of these gradients is to ensure that an ultra-low interfacial tension Winsor type III microemulsion is created at the leading edge where oil and surfactant mix. In the trailing edge we require the surfactants to stay in water and hence a Winsor type I microemulsion. By using a salinity gradient where the chase salinity is less than the surfactant slug salinity, a salinity gradient can be induced. Winsor Type I behavior can also be achieved by using an alcohol, anionic surfactant, or a surfactant or solvent that makes the system more hydrophilic in the chase solutions.

The transition from Type I to Type III microemulsion without altering salinity was achieved by employing dimethyl ether (DME), which partitions into the oil phase. Such partitioning alters the apparent oil equivalent alkane carbon number (EACN). Once the oil EACN is reduced it results in a decrease in optimal salinity. By tailoring the concentration of the miscible solvent (e.g., DME) in the surfactant slug, a Type I microemulsion can be injected and by miscible solvent (e.g., DME) partitioning a Winsor Type III behavior can be induced. If the oil composition is unknown then a miscible solvent (e.g., DME) concentration that results in Type II behavior can be achieved when mixed and as the miscible solvent (e.g., DME) dilutes and moves towards Winsor Type I via a Type III, thereby providing a natural chemical or salinity gradient. Another advantage of using miscible solvent (e.g., DME) in the surfactant slug is that the miscible solvent (e.g., DME) reduces both oil and microemulsion viscosity which improves stability of displacement.

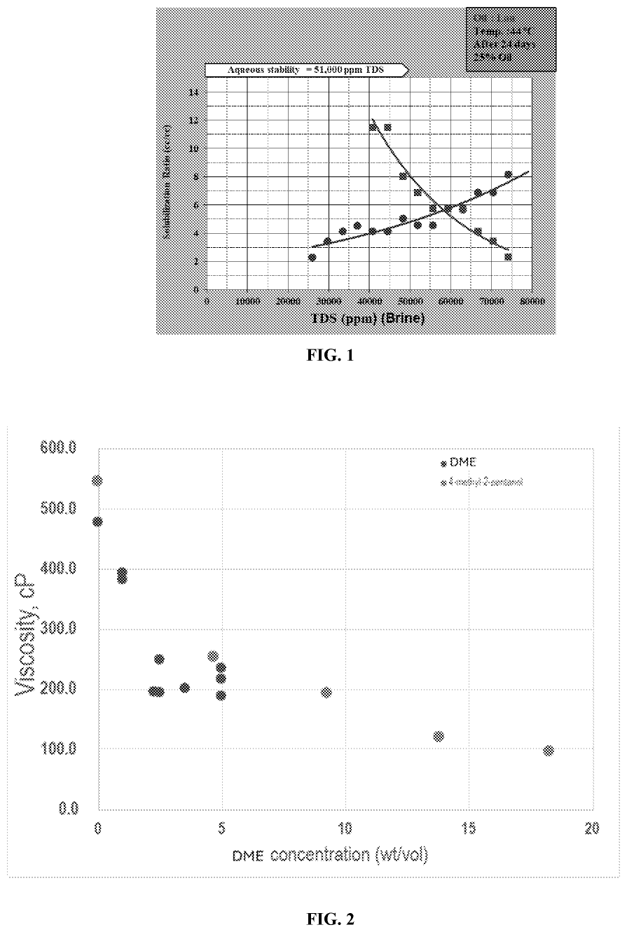

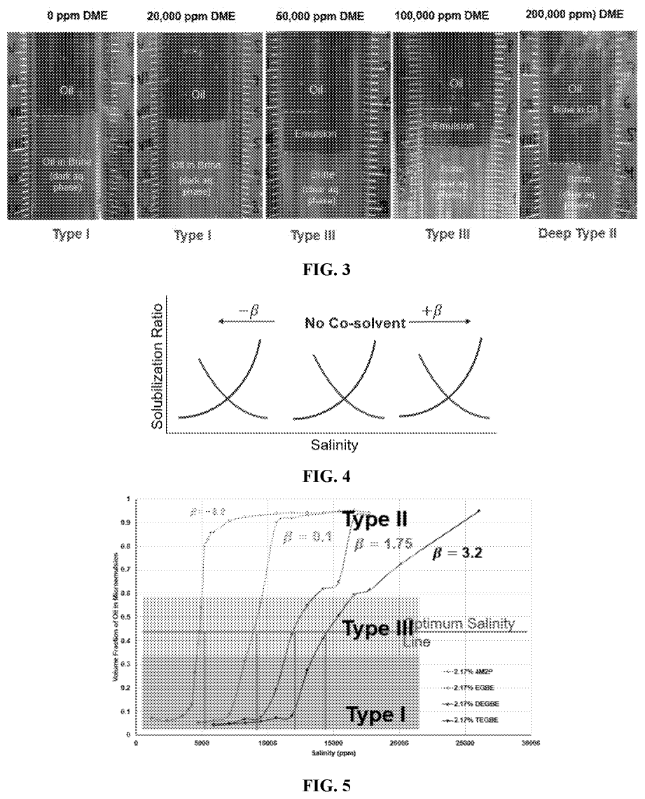

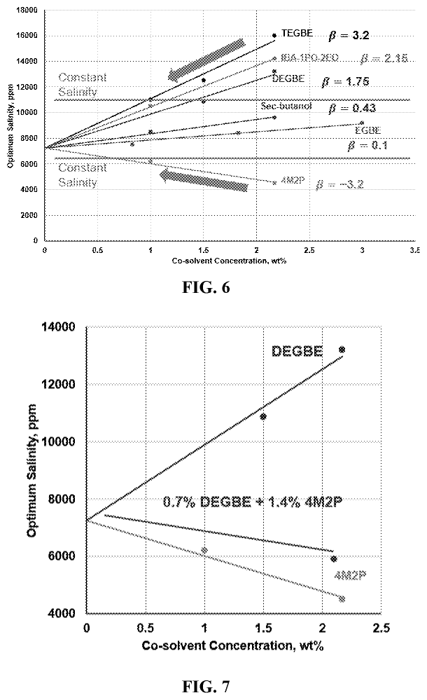

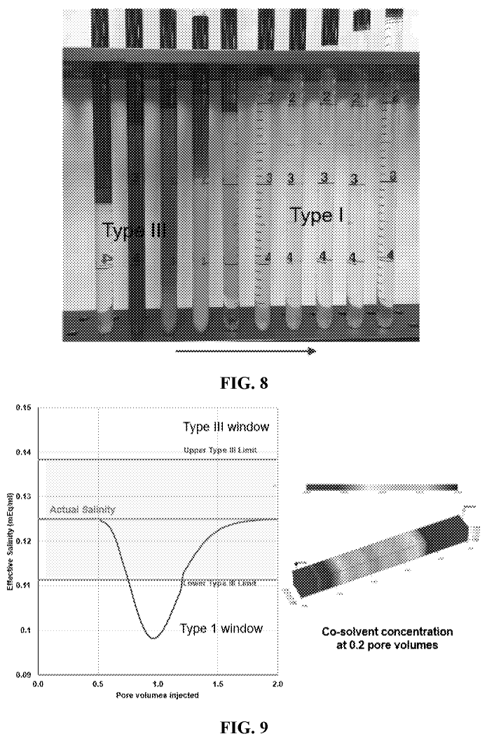

The following experiments demonstrate such phase behavior. Initially, phase behavior experiments were conducted with a surfactant formulation without DME as shown in FIG. 1. FIG. 1 shows that a Winsor Type I microemulsion is observed at a salinity 37,000 ppm at 44° C. Upon mixing 50,000 mg/L DME with the surfactant at the same salinity the phase behavior is shifted to a Winsor Type III microemulsion. When 20,000 mg/L DME is used in the surfactant solution, an over optimum Winsor Type III microemulsion can be seen. Thereby, the phase behavior can be shifted from a Winsor Type I to III at constant salinity by varying DME concentration. By using DME as a miscible solvent a salinity gradient can be mimicked at constant salinity.

Oil-soluble miscible solvents can give a desirable shift in optimum salinity that allows for chemical gradients at constant salinity. β parameter describes miscible solvent solubility in oil or water. Miscible solvent concentration and phase behavior data matched to UTCHEM simulator outputs. See FIG. 4.

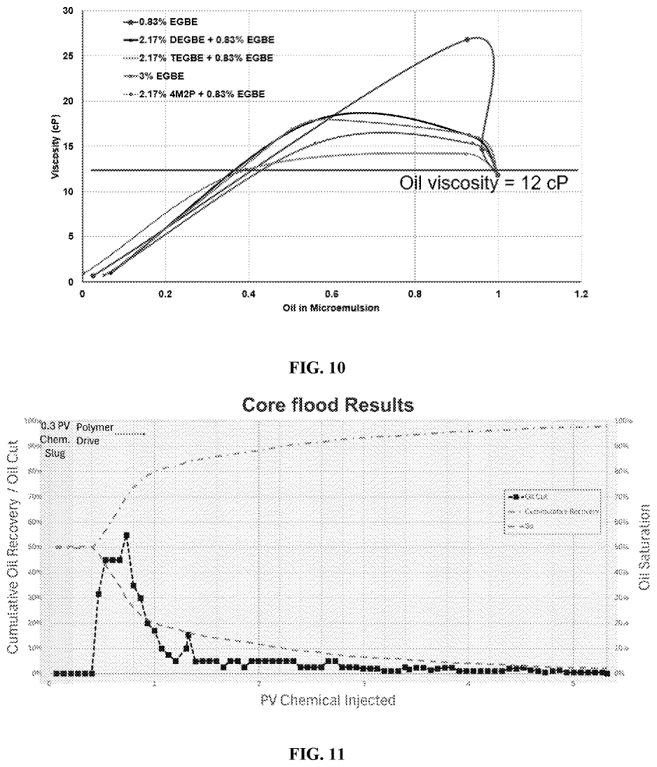

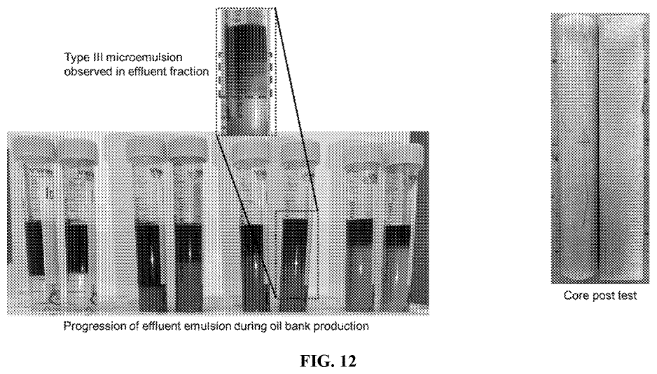

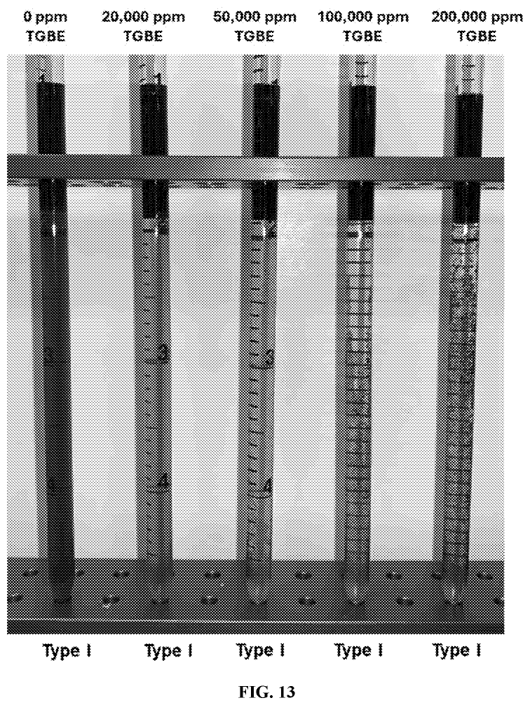

As demonstrated in FIG. 6 miscible solvents with negative β value increase the optimum salinity when diluted, thus, a type III microemulsion turns into a type I microemulsion at constant salinity. Miscible solvents with positive β value decrease the optimum salinity when diluted, thus, a Type III microemulsion turns into a over optimum or Type II microemulsion at constant salinity. Miscible solvents can be selected to minimize microemulsion viscosity. Viscosity of microemulsions is lower with 4-methyl-2-pentanol. See FIG. 10.

TABLE 1
List of miscible solvent investigated
and miscible solvent partitioning.

| Miscible Solvents | β | K_{ow} | K_{pw} |
|---|---|---|---|
| ethylene glycol monobutyl ether | 0.1 | 1.35 | 15 |
| (EGBE) | | | |
| diethylene glycol monobutyl ether | 1.75 | 0.68 | 20 |
| (DEGBE) | | | |
| triethylene glycol monobutyl ether | 3.2 | 0.6 | 20 |
| (TEGBE) | | | |
| 4-methyl-2-pentanol (4M2P) | −3.2 | 1.7 | 25 |
| 4-methyl-2-pentanol-1PO-5EO | | | |
| isobutyl alcohol (IBA) | | | |
| isobutyl alcohol-1PO-2EO | | | |
| sec-butanol | 0.43 | 1.7 | 9 |
| isopropyl alcohol (IPA) | | | |
| phenol-2PO-2EO | | | |
| phenol-1PO-5EO | | | |

### Example 2: Core Flood Study

Core conditions: benthiemer core, dimensions (Dia×Length): 2″×12″, permeability: 2.6 D, porosity: 25%, temperature: 44° C., crude oil visc. (at 44° C.): 5.5 cP, original oil in place: 106 mL, initial oil saturation: 70%, waterflood recovery: 53.4 mL, Sorw: 35%.

Chemical flood: chemical slug: 0.3 pore volumes (PV) of 1.45% CS4320, 5% DME and 5000 ppm polymer. Polymer drive: 5000 ppm polymer, cumulative chemical recovery: 51.1 mL, residual oil post chemical: 1.5 mL.

### Initial Core Preparation and Characterization

The core was dried at 75° C. overnight, and its dry mass was recorded. It was then loaded into a triaxial core holder, and an initial overburden pressure of 300 psi was applied. Next, the core was evacuated under vacuum and saturated with synthetic reservoir brine (the same brine was used in all core flood steps). The saturated core mass was measured, and pore volume (PV) was calculated from the difference between the dry and saturated masses using the brine density.

The core holder was then connected to a core flood system housed in an oven at 44° C. The overburden pressure increased to 500 psi, and the pore pressure (backpressure) was raised to approximately 150 psi. The initial permeability of the virgin core was measured at multiple flow rates.

A conservative tracer (2,7-naphthalenedisulfonic acid) was injected for over 2 PV to confirm the measured pore volume and to establish a baseline tracer profile for the clean core. This baseline tracer profile was recorded for later use in evaluating the effectiveness of the chemical treatment.

### Oil Saturation

After core characterization, 1.5 PV of reservoir crude oil was injected at an interstitial velocity of 40 ft/day. Oil injection continued until the effluent was ~99.9% oil, indicating that maximum oil saturation had been achieved. The volume of water displaced by the oil was recorded to determine the initial oil in place and the corresponding oil saturation. The oil-saturated core was then aged for 4 days at 44° C. Following this aging period, a waterflood was performed by injecting synthetic reservoir brine at an interstitial velocity of 5 ft/day until the effluent was ~99.9% brine. The volume of oil recovered during the waterflood was measured to calculate the residual oil saturation after waterflooding (Sorw). A second tracer injection (using 2,7-naphthalenedisulfonic acid) was conducted after the waterflood to confirm Sorw by mass balance and to demonstrate the shift in tracer response due to crude oil occupying pore space.

### Preparation of Chemical Slugs

Special preparation was necessary for the chemical slug due to the properties of DME (dimethyl ether). Raw DME was not added directly to the fluid stream because it can cause polymer precipitation; instead, it was first diluted with brine before slug preparation.

Using a separate pressurized setup, DME was compressed and added into synthetic brine while maintaining a pressure above 150 psi to keep it in the liquid phase. This produced a 10% wt/vol DME solution, which was collected in an accumulator equipped with a piston and mixing ball. The accumulator was periodically rocked to agitate the fluid and ensure a homogeneous DME/brine mixture.

In a second accumulator (also equipped with a piston and mixing ball), a predetermined volume of a 2× concentrated surfactant/polymer solution was prepared. This 2× concentrate was chosen such that when mixed 1:1 with the 10% DME/brine solution, the final slug would contain 5% wt/vol DME and a 1× concentration of surfactant and polymer. Both accumulators (and all connecting lines) were maintained above 150 psi to prevent any DME phase change.

Once both components were ready, the DME/brine solution was combined 1:1 with the surfactant/polymer solution to form the final chemical slug. The mixture was agitated again for thorough mixing, then placed in an oven at 44° C. and kept at a pressure above 170 psi (using a pump) to prevent DME off-gassing. The combined chemical solution was aged overnight at 44° C. and high pressure to ensure thermal equilibrium and full homogenization. The slug was agitated once more before being connected to the core flood system for injection.

### Chemical Injection

The prepared chemical slug (5% wt/vol DME, 5000 ppm polymer, and 1.45% surfactant in brine) accumulator was gradually introduced into the core flood system keeping system pressures above 170 psi to prevent DME off-gassing.

Once the system was fully primed with the chemical slug, 0.3 PV of slug was injected at an interstitial velocity of 1 ft/day. Immediately afterward, a polymer chase (5000 ppm polymer in brine, with no surfactant or DME) was injected at the same 1 ft/day rate. Effluent samples were collected at intervals of 1/15 PV to monitor oil recovery and observe any emulsion behavior.

Polymer injection continued until no further oil was observed in the effluent (approximately 5 PV of polymer chase). Finally, after the polymer chase, a tracer flood was performed by injecting 2,7-naphthalenedisulfonic acid in a 5000 ppm polymer brine solution (to maintain favorable mobility of the tracer front). This final tracer injection confirmed the total oil recovery and was used to determine the residual oil saturation after chemical flooding (Sorc).

Final oil recovery was approximately 98% of the initial oil in place, confirmed by mass balance and by comparing the Sorc tracer profile with the initial (virgin core) tracer profile.

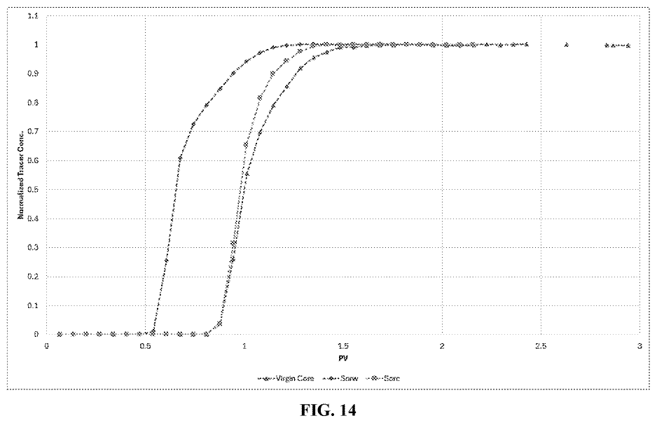

The results are shown in FIG. 11. The plot in FIG. 14 demonstrates a clear shift from the sorw response to the sorc response, with the Sorc tracer profile nearly overlapping the virgin core profile. This indicates that nearly 100% of the oil was recovered during the test, which is consistent with and confirms our mass balance recovery measurements. One may expect addition of a co-solvent to increase hydrocarbon recovery, however, it is unexpected that the addition of a miscible solvent would yield an oil recovery of greater than 95% as demonstrated in the Examples.

### EMBODIMENTS

Embodiment 1: A method for hydrocarbon recovery from a subterranean formation, the method comprising:
injecting a first aqueous formulation comprising a surfactant package, and a miscible solvent at a constant salinity into the subterranean formation via a wellbore in fluid communication with the subterranean formation;
allowing the first aqueous formulation to contact a rock matrix of the subterranean formation for a period of time; and
producing fluids from the subterranean formation through the wellbore;
wherein the miscible solvent is present in the first aqueous formulation in a concentration of from 0.1% by weight to 20% by weight;
wherein the miscible solvent and the surfactant package are present in the first aqueous formulation in a ratio of from 1:0.0005 to 1:200 (e.g., 1:10 or 1:1).

Embodiment 2: The method of embodiment 1, wherein the surfactant package is present in the first aqueous formulation in a concentration of from 0.01% by weight to 20% by weight.

Embodiment 3: The method of embodiment 1 or embodiment 2, wherein the method further comprises injecting a second aqueous formulation comprising a surfactant package a miscible solvent, an aqueous polymer, or any combination thereof at a constant salinity into the subterranean formation via a wellbore in fluid communication with the subterranean formation.

Embodiment 4: The method of embodiment 3, wherein when the miscible solvent is present, the miscible solvent is present in the second aqueous formulation in a concentration of from 0% by weight to 5% by weight (e.g., 0% to 2% by weight).

Embodiment 5: The method of embodiment 3 or embodiment 4, wherein when the surfactant package is present, the surfactant package is present in the second aqueous formulation in a concentration of from 0.01% by weight to 20% by weight.

Embodiment 6: The method of any one of embodiments 3-5, wherein when the miscible solvent is present in the second aqueous formulation, the miscible solvent and the surfactant package are present in the second aqueous formulation in a ratio of from 1:0.0005 to 1:200,000 (e.g., 1:0.1, 1:10, 1:100, 1:200, or 1:1).

Embodiment 7: The method of any one of embodiments 3-6, wherein injecting the second aqueous formulation takes place after the injection of the first aqueous formulation.

Embodiment 8: A method for hydrocarbon recovery from a subterranean formation, the method comprising:
injecting a first aqueous formulation comprising surfactant package and a miscible solvent at a constant salinity into the subterranean formation via a wellbore in fluid communication with the subterranean formation, wherein the miscible solvent is present in the first aqueous formulation in an effective amount such that, in the presence of formation fluids, the first aqueous formulation and the formation fluids passes through a Winsor type III phase, thereby providing ultra-low interfacial tension between oil and aqueous phases;
allowing the first aqueous formulation to contact a rock matrix of the subterranean formation for a period of time; and
producing fluids from the subterranean formation through the wellbore;
wherein the miscible solvent is present in the first aqueous formulation in a concentration of from 0.1% by weight to 20% by weight;
wherein the miscible solvent and the surfactant package are present in the first aqueous formulation in a ratio of from 1:0.0005 to 1:200 (e.g., 1:10 or 1:1).

Embodiment 9: The method of embodiment 8, wherein the method further comprises injecting a second aqueous formulation comprising surfactant package, a miscible solvent, an aqueous polymer, or any combination thereof at a constant salinity into the subterranean formation via a wellbore in fluid communication with the subterranean formation.

Embodiment 10: The method of embodiment 9, wherein when the miscible solvent is present, the miscible solvent is present in the second aqueous formulation in an effective amount to produce a type I microemulsion.

Embodiment 11: The method of any one of embodiments 9-10, wherein when the miscible solvent is present, the miscible solvent is present in the second aqueous formulation in a concentration lower than a concentration of a same miscible solvent in the first aqueous formulation.

Embodiment 12: The method of any one of embodiments 1-12, wherein the miscible solvent comprises dimethyl ether (DME).

Embodiment 13: The method of any of embodiments 1-12, wherein the miscible solvent comprises neat dimethyl ether.

Embodiment 14: The method of any one of embodiments 12-13, wherein the miscible solvent further comprises the sacrificial co-solvent is selected from: ethylene glycol monobutyl ether (EGBE), diethylene glycol monobutyl ether (DEGBE), triethylene glycol monobutyl ether (TEGBE), C4-C9 alcohol (e.g., 4-methyl-2-pentanol (also known as methylisobutyl carbinol), hexanol (e.g., n-hexanol), 2-ethylhexanol (e.g., 2-ethyl-1-hexanol), 2-butoxyethanol, benzyl alcohol, isopropyl alcohol (IPA), isobutyl alcohol (IBA), sec-butanol, tert-butanol, pentaerythritol, trimethylolpropane), 4-methyl-2-pentanol-1PO-5EO, isobutyl alcohol-1PO-2EO, phenol-2PO-2EO, phenol-1PO-5EO, or any combination thereof.

Embodiment 15: The method of any one of embodiments 12-14, wherein the sacrificial co-solvent is selected from: C₄-C₉ alcohol (e.g., 4-methyl-2-pentanol (also known as methylisobutyl carbinol), hexanol (e.g., n-hexanol), 2-ethylhexanol (e.g., 2-ethyl-1-hexanol), 2-butoxyethanol, benzyl alcohol, sec-butanol, tert-butanol, pentaerythritol, trimethylolpropane), or any combination thereof.

Embodiment 16: The method of any of embodiments 1-15, wherein the first aqueous formulation and/or the second aqueous formulation further comprises an aqueous polymer.

Embodiment 17: The method of embodiment 16, wherein the aqueous polymer comprises a synthetic polymer, a naturally occurring polymer (a biopolymer), self-destructing polymer, or any combination thereof.

Embodiment 18: The method of any one of embodiments 16-17, wherein the aqueous polymer comprises a polymer concentration of from 500 ppm to 10,000 ppm.

Embodiment 19: The method of any one of embodiments 1-18, wherein the subterranean formation is a conventional formation.

Embodiment 20: The method of any one of embodiments 1-18, wherein the subterranean formation is an unconventional formation.

Embodiment 21: The method of any one of embodiments 1-20, wherein the first aqueous formulation reduces the microemulsion viscosity by 5% to 50%, (e.g., 5% to 25%) relative to the same first aqueous formulation without a miscible solvent.

Embodiment 22: The method of any one of embodiments 1-21, wherein the allowing step comprises allowing the miscible solvent in the first aqueous formulation to partition into hydrocarbons present within the subterranean formation for a period of time.

Embodiment 23: The method of any one of embodiments 1-22, wherein the surfactant package can include an anionic surfactant, a non-ionic surfactant, a zwitterionic surfactant, or any combination thereof.

Embodiment 24: The method of any one of embodiments 1-23, wherein the surfactant package comprises a non-ionic surfactant, an anionic surfactant, or any combination thereof.

Embodiment 25: The method of any one of embodiments 23-24, wherein the anionic surfactant comprises a sulfonate, a disulfonate, a polysulfonate, a sulfate, a disulfate, a polysulfate, a sulfosuccinate, a disulfosuccinate, a polysulfosuccinate, a carboxylate, a dicarboxylate, a polycarboxylate, or any combination thereof.

Embodiment 26: The method of any one of embodiments 23-25, wherein the anionic surfactant comprises a branched or unbranched C6-C32:PO(0-65):EO(0-100)-carboxylate, a branched or unbranched C6-C30:PO(30-40):EO(25-35)-carboxylate, a branched or unbranched C6-C12:PO(30-40):EO(25-35)-carboxylate, a branched or unbranched C6-C30:EO(8-30)-carboxylate, or any combination thereof,
a surfactant defined by the formula below

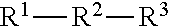

wherein
R¹ comprises a branched or unbranched, saturated or unsaturated, cyclic or non-cyclic, hydrophobic carbon chain having 6-32 carbon atoms and an oxygen atom linking R¹ and R²;
R² comprises an alkoxylated chain comprising at least one oxide group selected from the group consisting of ethylene oxide, propylene oxide, butylene oxide, and combinations thereof, and
R³ comprises a branched or unbranched hydrocarbon chain comprising 1-12 carbon atoms and from 1 to 5 carboxylate groups, from 1-3 sulfate groups, or from 1-3 sulfonate groups;
a C10-C30 internal olefin sulfonate, a C8-C30 alkyl benzene sulfonate (ABS), a sulfosuccinate surfactant, or any combination thereof, or
a surfactant defined by the formula below

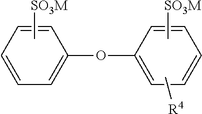

wherein
R⁴ is a branched or unbranched, saturated or unsaturated, cyclic or non-cyclic, hydrophobic carbon chain having 6-32 carbon atoms; and
M represents a counterion.

Embodiment 27: The method of any one of embodiments 23-24, wherein the non-ionic surfactant comprises a branched or unbranched C6-C32:PO(0-65):EO(0-100).

Embodiment 28: The method of any one of embodiments 1-27, wherein the liquid formulation further comprises an acid, an alkali agent, co-solvent, a co-surfactant, a foam stabilizer, a breaker, a friction reducer, a pH adjusting agent, an iron control agent, a corrosion inhibitor, a scale inhibitor, a biocide, a clay stabilizing agent, or any combination thereof or any combination thereof.

Embodiment 29: The method of any one of embodiments 1-28, wherein the first aqueous formulation and/or the second aqueous formulation further comprises a co-solvent.

Embodiment 30: The method of embodiment 28 or embodiment 29, wherein the co-solvent comprises a C₁-C₅ alcohol, an ethoxylated C₁-C₅ alcohol, supercritical CO₂, or any combination thereof.

Embodiment 31: The method of any of embodiments 1-30, wherein the first aqueous formulation and/or the second aqueous formulation further comprises water.

Embodiment 32: The method of embodiment 31, wherein the water comprises sea water, brackish water, flowback or produced water, wastewater (e.g., reclaimed or recycled), brine (e.g., reservoir or synthetic brine), fresh water (e.g., fresh water comprises <1,000 ppm TDS water), or any combination thereof.

Embodiment 33: The method of any of embodiments 32-32, wherein the water has a salinity of at least 5,000 ppm TDS, such as a salinity of from 30,000 ppm to 300,000 ppm TDS.

Embodiment 34: The method of any one of embodiments 1-33, wherein the first aqueous formulation has an interfacial tension of 0.1 dynes/cm or less (e.g., from 0.001 to 0.01 dynes/cm) with a hydrocarbon phase present in the subterranean formation.

Embodiment 35: The method of any one of embodiments 1-34, wherein when the miscible solvent is present the second aqueous formulation has an interfacial tension of 0.1 dynes/cm or less (e.g., from 0.001 to 0.01 dynes/cm) with a hydrocarbon phase present in the subterranean formation.

Embodiment 36: The method of any one of embodiments 1-35, wherein the subterranean formation has a permeability of from 1.0×10-6 mD to 10 mD.

Embodiment 37: The method of any one of embodiments 1-36, wherein the liquid formulation is injected in an effective amount to reduce the viscosity of the hydrocarbons present within the subterranean formation by from 1% to 50%, such as 25% to 50%.

Embodiment 38: The method of any of embodiments 1-37, wherein the hydrocarbons present within the subterranean formation comprise light oil.

Embodiment 39: The method of embodiment 38, wherein the light oil has an API gravity of from 40 to 60.

Embodiment 40: The method of any of embodiments 1-37, wherein the hydrocarbons present within the subterranean formation comprise heavy oil.

Embodiment 41: The method of embodiment 40, wherein the heavy oil has an API gravity of at least 10, such as from 10 to 25.

Embodiment 42: The method of any of embodiments 1-41, wherein the first aqueous formulation and/or the second aqueous formulation is injected at a wellhead pressure of from 200 PSI up to 10,000 PSI, such as 6,000 PSI to 10,000 PSI, from 5,000 PSI to 10,000 PSI.

Embodiment 43: The method of any of embodiments 1-42, wherein the subterranean formation has a temperature of from 75° F. to 350° F., such as from 130° F. to 250° F., from 100° F. to 250° F., from 150° F. to 180° F., or from 150° F. to 250° F.

Embodiment 44: The method of any of embodiments 1-43, wherein the subterranean formation has a salinity of at least 5,000 ppm TDS, such as a salinity of from 5,000 ppm TDS to 300,000 ppm TDS, from 30,000 ppm TDS to 300,000 ppm TDS, from 30,000 ppm TDS to 220,000 ppm TDS, or from 100,000 ppm to 300,000 ppm TDS.

Embodiment 45: The method of any one of embodiments 1-44, wherein the method improves the hydrocarbon recovery by at least 10% relative to injection of brine having a TDS of 50,000 ppm.

Embodiment 46: The method of any one of embodiments 1-45, wherein the method improves the hydrocarbon recovery from 10% to 80%, such as 25% relative to injection of brine having a TDS of 50,000 ppm.

Embodiment 47: The method of any one of embodiments 1-46, wherein the miscible solvent exhibits a partition coefficient of from 0.01 to 3, such as 0.5 to 2.5 with the hydrocarbons present in the subterranean formation.

Embodiment 48: A method for hydrocarbon recovery from a subterranean formation, the method comprising:
injecting a first aqueous formulation comprising a surfactant package, and a miscible solvent at a constant salinity into the subterranean formation via an injection wellbore in fluid communication with the subterranean formation; and
producing fluids from the subterranean formation through a production wellbore spaced apart from the injection wellbore a predetermined distance and in fluid communication with the subterranean formation;
wherein the miscible solvent is present in the first aqueous formulation in a concentration of from 0.1% by weight to 20% by weight;
wherein the miscible solvent and the surfactant package are present in the first aqueous formulation in a ratio of from 1:0.0005 to 1:200 (e.g., 1:10 or 1:1).

Embodiment 50: The method of embodiment 48, wherein the surfactant package is present in the first aqueous formulation in a concentration of from 0.01% by weight to 20% by weight.

Embodiment 51: The method of embodiment 48 or embodiment 49, wherein the method further comprises injecting a second aqueous formulation comprising a surfactant package, and a miscible solvent at a constant salinity into the subterranean formation via an injection wellbore in fluid communication with the subterranean formation.

Embodiment 52: The method of embodiment 51, wherein when the miscible solvent is present, the miscible solvent is present in the second aqueous formulation in a concentration of from 0% by weight to 5% by weight (e.g., 0% to 2% by weight).

Embodiment 53: The method of embodiment 50 or embodiment 51, wherein when the surfactant is present, the surfactant package is present in the second aqueous formulation in a concentration of from 0.01% by weight to 20% by weight.

Embodiment 54: The method of any one of embodiments 50-52, wherein when the miscible solvent is present in the second aqueous formulation, the miscible solvent and the surfactant package are present in the second aqueous formulation in a ratio of from 1:0.0005 to 1:200,000 (e.g., 1:0.1, 1:10, 1:100, 1:200, or 1:1).

Embodiment 55: The method of any one of embodiments 50-53, wherein injecting the second aqueous formulation takes place after the injection of the first aqueous formulation.

Embodiment 56: A method for hydrocarbon recovery from a subterranean formation, the method comprising:
injecting a first aqueous formulation comprising surfactant package and a miscible solvent at a constant salinity into the subterranean formation via an injection wellbore in fluid communication with the subterranean formation, wherein the miscible solvent is present in the first aqueous formulation in an effective amount such that, in the presence of formation fluids, the first aqueous formulation and the formation fluids passes through a Winsor type III phase, thereby providing ultra-low interfacial tension between oil and aqueous phases; and
producing fluids from the subterranean formation through a production wellbore spaced apart from the injection wellbore a predetermined distance and in fluid communication with the subterranean formation;
wherein the miscible solvent is present in the first aqueous formulation in a concentration of from 0.1% by weight to 20% by weight;
wherein the miscible solvent and the surfactant package are present in the first aqueous formulation in a ratio of from 1:0.0005 to 1:200 (e.g., 1:10 or 1:1).

Embodiment 57: The method of embodiment 55, wherein the method further comprises injecting a second aqueous formulation comprising surfactant package, a miscible solvent, an aqueous polymer, or any combination thereof at a constant salinity into the subterranean formation via a wellbore in fluid communication with the subterranean formation.

Embodiment 58: The method of embodiment 56, wherein when the miscible solvent is present, the miscible solvent is present in the second aqueous formulation in an effective amount to produce a type I microemulsion.

Embodiment 59: The method of any one of embodiments 56-58, wherein when the miscible solvent is present, the miscible solvent is present in the second aqueous formulation in a concentration lower than a concentration of a same miscible solvent in the first aqueous formulation.

Embodiment 60: The method of any one of embodiments 48-59, wherein the miscible solvent comprises dimethyl ether (DME).

Embodiment 61: The method of any of embodiments 48-60, wherein the miscible solvent comprises neat dimethyl ether.

Embodiment 62: The method of any one of embodiments 48-61, wherein the miscible solvent further comprises a sacrificial co-solvent is selected from: ethylene glycol monobutyl ether (EGBE), diethylene glycol monobutyl ether (DEGBE), triethylene glycol monobutyl ether (TEGBE), C4-C9 alcohol (e.g., 4-methyl-2-pentanol (also known as methylisobutyl carbinol), hexanol (e.g., n-hexanol), 2-ethylhexanol (e.g., 2-ethyl-1-hexanol), 2-butoxyethanol, benzyl alcohol, isopropyl alcohol (IPA), isobutyl alcohol (IBA), sec-butanol, tert-butanol, pentaerythritol, trimethylolpropane), 4-methyl-2-pentanol-1PO-5EO, isobutyl alcohol-1PO-2EO, phenol-2PO-2EO, phenol-1PO-5EO, or any combination thereof.

Embodiment 63: The method of embodiment 62, wherein the sacrificial co-solvent is selected from: C₄-C₉ alcohol (e.g., 4-methyl-2-pentanol (also known as methylisobutyl carbinol), hexanol (e.g., n-hexanol), 2-ethylhexanol (e.g., 2-ethyl-1-hexanol), 2-butoxyethanol, benzyl alcohol, sec-butanol, tert-butanol, pentaerythritol, trimethylolpropane), or any combination thereof.

Embodiment 64: The method of any of embodiments 48-63, wherein the first aqueous formulation and/or the second aqueous formulation further comprises an aqueous polymer.

Embodiment 65: The method of embodiment 64, wherein the aqueous polymer comprises a synthetic polymer, a naturally occurring polymer (a biopolymer), self-destructing polymer, or any combination thereof.

Embodiment 66: The method of any one of embodiments 64-65, wherein the aqueous polymer comprises a polymer concentration of from 500 ppm to 10,000 ppm.

Embodiment 67: The method of any one of embodiments 48-66, wherein the subterranean formation is a conventional formation.

Embodiment 68: The method of any one of embodiments 48-67, wherein the first aqueous formulation reduces the microemulsion viscosity by 5% to 50%, (e.g., 5% to 25%) relative to the same first aqueous formulation without a miscible solvent.

Embodiment 69: The method of any one of embodiments 48-68, wherein the surfactant package can include an anionic surfactant, a non-ionic surfactant, a zwitterionic surfactant, or any combination thereof.

Embodiment 70: The method of any one of embodiments 48-69, wherein the surfactant package comprises a non-ionic surfactant, an anionic surfactant, or any combination thereof.

Embodiment 71: The method of any one of embodiments 69-70, wherein the anionic surfactant comprises a sulfonate, a disulfonate, a polysulfonate, a sulfate, a disulfate, a polysulfate, a sulfosuccinate, a disulfosuccinate, a polysulfosuccinate, a carboxylate, a dicarboxylate, a polycarboxylate, or any combination thereof.

Embodiment 72: The method of any one of embodiments 69-71, wherein the anionic surfactant comprises a branched or unbranched C6-C32:PO(0-65):EO(0-100)-carboxylate, a branched or unbranched C6-C30:PO(30-40):EO(25-35)-carboxylate, a branched or unbranched C6-C12:PO(30-40):EO(25-35)-carboxylate, a branched or unbranched C6-C30:EO(8-30)-carboxylate, or any combination thereof,
a surfactant defined by the formula below

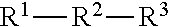

wherein
R¹ comprises a branched or unbranched, saturated or unsaturated, cyclic or non-cyclic, hydrophobic carbon chain having 6-32 carbon atoms and an oxygen atom linking R¹ and R²;
R² comprises an alkoxylated chain comprising at least one oxide group selected from the group consisting of ethylene oxide, propylene oxide, butylene oxide, and combinations thereof, and
R³ comprises a branched or unbranched hydrocarbon chain comprising 1-12 carbon atoms and from 1 to 5 carboxylate groups, from 1-3 sulfate groups, or from 1-3 sulfonate groups;
a C10-C30 internal olefin sulfonate, a C8-C30 alkyl benzene sulfonate (ABS), a sulfosuccinate surfactant, or any combination thereof, or
a surfactant defined by the formula below

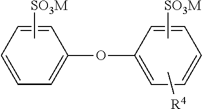

wherein
R⁴ is a branched or unbranched, saturated or unsaturated, cyclic or non-cyclic, hydrophobic carbon chain having 6-32 carbon atoms; and
M represents a counterion.

Embodiment 73: The method of any one of embodiments 69-71, wherein the non-ionic surfactant comprises a branched or unbranched C6-C32:PO(0-65):EO(0-100).

Embodiment 74: The method of any one of embodiments 48-75, wherein the liquid formulation further comprises an acid, an alkali agent, co-solvent, a co-surfactant, a foam stabilizer, a breaker, a friction reducer, a pH adjusting agent, an iron control agent, a corrosion inhibitor, a scale inhibitor, a biocide, a clay stabilizing agent, or any combination thereof or any combination thereof.

Embodiment 75: The method of any one of embodiments 48-74, wherein the first aqueous formulation and/or the second aqueous formulation further comprises a co-solvent.

Embodiment 76: The method of embodiment 74 or embodiment 75, wherein the co-solvent comprises a C₁-C₅ alcohol, an ethoxylated C₁-C₅ alcohol, supercritical CO₂, or any combination thereof.

Embodiment 77: The method of any of embodiments 48-76, wherein the first aqueous formulation and/or the second aqueous formulation further comprises water.

Embodiment 78: The method of embodiment 77, wherein the water comprises sea water, brackish water, flowback or produced water, wastewater (e.g., reclaimed or recycled), brine (e.g., reservoir or synthetic brine), fresh water (e.g., fresh water comprises <1,000 ppm TDS water), or any combination thereof.

Embodiment 79: The method of any of embodiments 77-78, wherein the water has a salinity of at least 5,000 ppm TDS, such as a salinity of from 30,000 ppm to 300,000 ppm TDS.

Embodiment 80: The method of any one of embodiments 48-79, wherein the first aqueous formulation has an interfacial tension of 0.1 dynes/cm or less (e.g., from 0.001 to 0.01 dynes/cm) with a hydrocarbon phase present in the subterranean formation.

Embodiment 81: The method of any one of embodiments 48-80, wherein when the miscible solvent is present the second aqueous formulation has an interfacial tension of 0.1 dynes/cm or less (e.g., from 0.001 to 0.01 dynes/cm) with a hydrocarbon phase present in the subterranean formation.

Embodiment 82: The method of any one of embodiments 48-81, wherein the subterranean formation has a permeability of from 1.0×10-6 mD to 10 mD.

Embodiment 83: The method of any one of embodiments 48-82, wherein the liquid formulation is injected in an effective amount to reduce the viscosity of the hydrocarbons present within the subterranean formation by from 1% to 50%, such as 25% to 50%.

Embodiment 84: The method of any of embodiments 48-83, wherein the hydrocarbons present within the subterranean formation comprise light oil.

Embodiment 85: The method of embodiment 84, wherein the light oil has an API gravity of from 40 to 60.

Embodiment 86: The method of any of embodiments 48-85, wherein the hydrocarbons present within the subterranean formation comprise heavy oil.

Embodiment 87: The method of embodiment 86, wherein the heavy oil has an API gravity of at least 10, such as from 10 to 25.

Embodiment 88: The method of any of embodiments 48-89, wherein the first aqueous formulation and/or the second aqueous formulation is injected at a wellhead pressure of from 200 PSI up to 10,000 PSI, such as 6,000 PSI to 10,000 PSI, from 5,000 PSI to 10,000 PSI.

Embodiment 89: The method of any of embodiments 48-88, wherein the subterranean formation has a temperature of from 75° F. to 350° F., such as from 130° F. to 250° F., from 100° F. to 250° F., from 150° F. to 180° F., or from 150° F. to 250° F.

Embodiment 90: The method of any of embodiments 48-89, wherein the subterranean formation has a salinity of at least 5,000 ppm TDS, such as a salinity of from 5,000 ppm TDS to 300,000 ppm TDS, from 30,000 ppm TDS to 300,000 ppm TDS, from 30,000 ppm TDS to 220,000 ppm TDS, or from 100,000 ppm to 300,000 ppm TDS.

Embodiment 91: The method of any one of embodiments 48-90, wherein the method improves the hydrocarbon recovery by at least 10% relative to injection of brine having a TDS of 50,000 ppm.

Embodiment 92: The method of any one of embodiments 48-91, wherein the method improves the hydrocarbon recovery from 10% to 80%, such as 25% relative to injection of brine having a TDS of 50,000 ppm.

Embodiment 93: The method of any one of embodiments 48-92, wherein the miscible solvent exhibits a partition coefficient of from 0.01 to 3, such as 0.5 to 2.5 with the hydrocarbons present in the subterranean formation.

Embodiment 94: The method of any one of embodiment 1-93, wherein when the first aqueous formulation is injected into a core comprising a surrogate rock for the subterranean formation at an interstitial velocity of 1 ft/day and at a temperature of 44° C., a total hydrocarbon recovery of at least a 95% (e.g., from 95% to 100%) is achieved.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

What is claimed is:

1. A method for hydrocarbon recovery from a subterranean formation, the method comprising:
injecting a first aqueous formulation comprising a surfactant package, and a miscible solvent comprising dimethyl ether (DME) at a constant salinity into the subterranean formation via a wellbore in fluid communication with the subterranean formation; and
producing fluids from the subterranean formation through the wellbore, a production wellbore spaced apart from the wellbore a predetermined distance and in fluid communication with the subterranean formation, or any combination thereof;
wherein the miscible solvent is present in the first aqueous formulation in a concentration of from 0.1% by weight to 20% by weight;
wherein the miscible solvent and the surfactant package are present in the first aqueous formulation in a ratio of from 1:0.0005 to 1:200.

2. The method of claim 1, wherein the surfactant package is present in the first aqueous formulation in a concentration of from 0.01% by weight to 20% by weight.

3. The method of claim 1, wherein the method further comprises injecting a second aqueous formulation comprising a surfactant package, a miscible solvent, an aqueous polymer, or any combination thereof at a constant salinity into the subterranean formation via the injection wellbore in fluid communication with the subterranean formation.

4. The method of claim 3, wherein when the surfactant package is present, the miscible solvent is present in the second aqueous formulation in a concentration of from 0% by weight to 5% by weight.

5. The method of claim 3, wherein when the surfactant package is present, the surfactant package is present in the second aqueous formulation in a concentration of from 0.01% by weight to 20% by weight.

6. The method of claim 3, wherein when the miscible solvent is present in the second aqueous formulation, the miscible solvent and the surfactant package are present in the second aqueous formulation in a ratio of from 1:0.0005 to 1:200,000.

7. The method of claim 1, wherein the miscible solvent further comprises a sacrificial co-solvent selected from: ethylene glycol monobutyl ether (EGBE), diethylene glycol monobutyl ether (DEGBE), triethylene glycol monobutyl ether (TEGBE), C₄-C₉ alcohol, 4-methyl-2-pentanol-1PO-5EO, isobutyl alcohol-1PO-2EO, phenol-2PO-2EO, phenol-1PO-5EO, or any combination thereof.

8. The method of claim 1, wherein the first aqueous formulation and/or the second aqueous formulation further comprises an aqueous polymer.

9. The method of claim 1, wherein the first aqueous formulation reduces the microemulsion viscosity by 5% to 50%, relative to the same first aqueous formulation without a miscible solvent.

10. The method of claim 1, wherein the surfactant package comprises an anionic surfactant, a non-ionic surfactant, a zwitterionic surfactant, or any combination thereof.

11. The method of claim 10, wherein the anionic surfactant comprises a sulfonate, a disulfonate, a polysulfonate, a sulfate, a disulfate, a polysulfate, a sulfosuccinate, a disulfosuccinate, a polysulfosuccinate, a carboxylate, a dicarboxylate, a polycarboxylate, or any combination thereof.

12. The method of claim 1, wherein the first aqueous formulation has an interfacial tension of 0.1 dynes/cm or less with a hydrocarbon phase present in the subterranean formation.

13. The method of claim 1, wherein the method improves the hydrocarbon recovery by at least 10% relative to injection of brine having a TDS of 50,000 ppm.

14. The method of claim 1, wherein the miscible solvent exhibits a partition coefficient of from 0.01 to 3 with the hydrocarbons present in the subterranean formation.

15. The method of claim 1, wherein when the first aqueous formulation is injected into a core comprising a surrogate rock for the subterranean formation at an interstitial velocity of 1 ft/day and at a temperature of 44° C., a total hydrocarbon recovery of at least a 95% (e.g., from 95% to 100%) is achieved.

16. The method of claim 1, wherein the miscible solvent is present in the first aqueous formulation in an effective amount such that, in the presence of formation fluids, the first aqueous formulation and the formation fluids passes through a Winsor type III phase, thereby providing ultra-low interfacial tension between oil and aqueous phases.

17. The method of claim 1, wherein the method comprises:
injecting a first aqueous formulation comprising a surfactant package, and a miscible solvent at a constant salinity into the subterranean formation via a wellbore in fluid communication with the subterranean formation;
allowing the first aqueous formulation to contact a rock matrix of the subterranean formation for a period of time; and
producing fluids from the subterranean formation through the wellbore;
wherein the miscible solvent is present in the first aqueous formulation in a concentration of from 0.1% by weight to 20% by weight;
wherein the miscible solvent and the surfactant package are present in the first aqueous formulation in a ratio of from 1:0.0005 to 1:200.

18. A method for hydrocarbon recovery from a subterranean formation, the method comprising:
injecting a first aqueous formulation comprising surfactant package and a miscible solvent at a constant salinity into the subterranean formation via an wellbore in fluid communication with the subterranean formation, wherein the miscible solvent is present in the first aqueous formulation in an effective amount such that, in the presence of formation fluids, the first aqueous formulation and the formation fluids passes through a Winsor type III phase, thereby providing ultra-low interfacial tension between oil and aqueous phases; and
producing fluids from the subterranean formation through the wellbore, a production wellbore spaced apart from the wellbore a predetermined distance and in fluid communication with the subterranean formation, or any combination thereof;
wherein the miscible solvent is present in the first aqueous formulation in a concentration of from 0.1% by weight to 20% by weight;
wherein the miscible solvent and the surfactant package are present in the first aqueous formulation in a ratio of from 1:0.0005 to 1:200.

19. The method of claim 18, wherein the method further comprises:
injecting a first aqueous formulation comprising surfactant package and a miscible solvent at a constant salinity into the subterranean formation via a wellbore in fluid communication with the subterranean formation, wherein the miscible solvent is present in the first aqueous formulation in an effective amount such that, in the presence of formation fluids, the first aqueous formulation and the formation fluids passes through a Winsor type III phase, thereby providing ultra-low interfacial tension between oil and aqueous phases;
allowing the first aqueous formulation to contact a rock matrix of the subterranean formation for a period of time; and
producing fluids from the subterranean formation through the wellbore;
wherein the miscible solvent is present in the first aqueous formulation in a concentration of from 0.1% by weight to 20% by weight;
wherein the miscible solvent and the surfactant package are present in the first aqueous formulation in a ratio of from 1:0.0005 to 1:200.

20. A method for improving hydrocarbon production from subterranean formation, the method comprising: injecting a first aqueous formulation including a surfactant package, and a miscible solvent at a constant salinity into the subterranean formation via a wellbore in fluid communication with the subterranean formation.
